(19) United States
(12) Patent Application Publication
(10) Pub. No.: US 2017/0009103 A1
(43) Pub. Date: Jan. 12, 2017

(54) PRESSURE-SENSITIVE ADHESIVES BASED ON CARBOXYLIC ACIDS AND EPOXIDES

(71) Applicant: OREGON STATE UNIVERSITY, Corvallis, OR (US)

(72) Inventors: Kaichang Li, Corvallis, OR (US); Anlong Li, Corvallis, OR (US)

(73) Assignee: Oregon State University, Corvallis, OR (US)

(21) Appl. No.: 15/113,772

(22) PCT Filed: Jan. 20, 2015
(86) PCT No.: PCT/US2015/012028

§ 371 Date: Jul. 22, 2016

Related U.S. Application Data
(60) Provisional application No. 61/931,422, filed on Jan. 24, 2014.

(51) Int. Cl. C09J 7/02; B32B 37/06; B32B 7/12; B32B 37/12; C09J 5/06; C09J 163/00

(52) U.S. Cl. CPC C09J 7/021; C09J 5/06; C09J 163/00; B32B 7/12; B32B 37/12; B32B 37/06; C09J 2203/334; B32B 2037/268

(57) ABSTRACT

A method for making a pressure sensitive adhesive comprising:
(a) reacting (i) at least one dibasic or polybasic carboxylic acid or anhydride thereof with (ii) at least one first epoxidized fatty acid at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group; and
(b) curing the resulting carboxylic acid-capped prepolymer or oligomer with at least one difunctional epoxide or polyfunctional epoxide, and optionally at least one second epoxidized fatty acid, to produce a pressure sensitive adhesive, wherein the difunctional epoxide or polyfunctional epoxide is not an epoxidized vegetable oil.

### CROSS REFERENCE TO RELATED APPLICATION

This application claims the benefit of the earlier filing date of U.S. Provisional Application No. 61/931,422, filed on Jan. 24, 2014. The contents of the prior application is incorporated herein by reference in its entirety.

### BACKGROUND

Pressure-sensitive adhesive (PSA, also known as “self-adhesive” or “self-stick adhesive”) is a distinct category of adhesives which in dry form (solvent/water free) are aggressively and permanently tacky at room temperature. PSAs form a bond at room temperature with a variety of dissimilar surfaces when light pressure is applied. No solvent, heat or radiation is needed to activate the adhesive. They find wide applications in pressure-sensitive tapes, general purpose labels, post-it notes, postage stamps, and a wide variety of other products, e.g., packaging, automobile trim assembly, sound/vibration damping films, maternity and child care products such as diapers, and hospital and first aid products such as wound care dressings. Nowadays, most commercially available PSAs are derived from acrylic, modified acrylic, rubber and silicone-based formulations.

Over the last several decades, application of epoxy resins has been primarily centered on thermosetting materials in industry, which were built on the lability of the oxirane or epoxy functionality to nucleophilic attack by amines, carboxylates and other species. Such epoxy thermosetting resins can be commonly found in powder coatings, solvent-free and solvent-borne coatings, composites for electrical laminates and two-part adhesives, etc. Despite the spectacular success of epoxy-based materials in the thermoset arena, thermoplastic epoxy polymers have received comparatively little attention. Only a few studies were documented on the stoichiometrically-balanced polymerizations of diglycidyl ethers with difunctional amines, bisphenols, difunctional sulfonamides, dicarboxylic acids or dithiols, yielding a family of thermoplastic resins (see, e.g., “Epoxy-based Thermoplastics: New Polymers With Unusual Property Profiles” by J. E. White, et al. (chapter 10 of the book Specialty Monomers and Polymers: Synthesis, Properties, and Applications, 2000), “Polyhydroxyethers. I. Effect of Structure on Properties of High Molecular Weight Polymers from Dihydric Phenols and Epichlorohydrin” by N. H. Reinking, et al. (J. Appl. Poylm. Sci. 1963)).

### SUMMARY

Disclosed herein in one embodiment is a method for making a pressure sensitive adhesive comprising:

(a) reacting (i) at least one dibasic or polybasic carboxylic acid or anhydride thereof with (ii) at least one first epoxidized fatty acid at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group; and

(b) curing the resulting carboxylic acid-capped prepolymer or oligomer with at least one difunctional epoxide or polyfunctional epoxide and optionally at least one second epoxidized fatty acid, to produce a pressure sensitive adhesive, wherein the difunctional epoxide or polyfunctional epoxide is not an epoxidized vegetable oil.

Also disclosed herein is a further embodiment for making a pressure sensitive adhesive comprising:

(a) reacting (i) at least one dibasic or polybasic carboxylic acid or anhydride thereof with (ii) at least one difunctional or polyfunctional epoxide, at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group, wherein the difunctional or polyfunctional epoxide is not an epoxidized vegetable oil; and

(b) curing the resulting carboxylic acid-capped prepolymer or oligomer with at least one epoxidized fatty acid to produce a pressure sensitive adhesive.

Also disclosed herein is a further embodiment for making a pressure sensitive adhesive comprising:

(a) reacting (i) at least one epoxidized fatty acid, (ii) at least one dibasic or polybasic carboxylic acid or anhydride thereof and (iii) at least one difunctional or polyfunctional epoxide to produce a thermoplastic prepolymer or oligomer, wherein the difunctional or polyfunctional epoxide is not an epoxidized vegetable oil; and

(b) curing the resulting thermoplastic prepolymer or oligomer optionally to produce a pressure sensitive adhesive.

Further disclosed herein is a pressure sensitive adhesive construct comprising:

(A) a backing substrate; and

(B) a pressure sensitive adhesive disposed on the backing substrate, wherein the pressure sensitive adhesive comprises a pressure sensitive adhesive made by any one of the methods disclosed herein.

Additionally disclosed herein is a method for making a pressure sensitive adhesive construct comprising:

(I) reacting (i) at least one dibasic or polybasic carboxylic acid or anhydride thereof with (ii) at least one first epoxidized fatty acid at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group; curing the resulting carboxylic acid-capped prepolymer or oligomer with at least one difunctional epoxide or polyfunctional epoxide and optionally at least one second epoxidized fatty acid, wherein the difunctional epoxide or polyfunctional epoxide is not an epoxidized vegetable oil; and forming on a backing substrate a pressure sensitive adhesive from the resulting reaction product; or

(II) reacting (i) at least one dibasic or polybasic carboxylic acid or anhydride thereof with (ii) at least one difunctional or polyfunctional epoxide, at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group, wherein the difunctional or polyfunctional epoxide is not an epoxidized vegetable oil; curing the resulting carboxylic acid-capped prepolymer or oligomer with at least one epoxidized fatty acid to produce a pressure sensitive adhesive; and forming on a backing substrate a pressure sensitive adhesive from the resulting reaction product; or

(III) reacting (i) at least one epoxidized fatty acid, (ii) at least one dibasic or polybasic carboxylic acid or anhydride thereof and (iii) at least one difunctional or polyfunctional epoxide to produce a thermoplastic prepolymer or oligomer, wherein the difunctional or polyfunctional epoxide is not an epoxidized vegetable oil; curing the resulting thermoplastic prepolymer or oligomer optionally to produce a pressure sensitive adhesive; and forming on a backing substrate a pressure sensitive adhesive from the resulting reaction product.

Further disclosed herein is a method for making a pressure sensitive adhesive construct, comprising:

applying pressure sensitive adhesive-forming ingredients to a backing substrate or a release liner;

applying a release liner to an opposing surface of the pressure sensitive adhesive-forming ingredients applied to the backing substrate to form a release liner/pressure sensitive adhesive-forming ingredients/backing substrate assembly, or applying a backing substrate to an opposing surface of the pressure sensitive adhesive-forming ingredients applied to the release liner to form a backing substrate/pressure sensitive adhesive-forming ingredients/release liner assembly;

applying at least one metal film to an outward surface of the release liner/pressure sensitive adhesive-forming ingredients/backing substrate assembly or to an outward surface of the backing substrate/pressure sensitive adhesive-forming ingredients/release liner assembly;

applying pressure to the resulting assembly; and

heating the resulting assembly to form a pressure sensitive adhesive.

Also disclosed herein is a method for making a pressure sensitive adhesive construct, comprising:

applying pressure sensitive adhesive-forming ingredients to a first release liner;

applying a second release liner to an opposing surface of the pressure sensitive adhesive-forming ingredients applied to the first release liner to form a first release liner/pressure sensitive adhesive-forming ingredients/second release liner assembly;

applying at least one metal film to an outward surface of the first release liner/pressure sensitive adhesive-forming ingredients/second release liner assembly;

applying pressure to the resulting assembly; and

heating the resulting assembly to form a pressure sensitive adhesive.

Additionally disclosed herein is a pressure sensitive adhesive made from (i) at least one dibasic acid or anhydride thereof, (ii) at least one epoxidized fatty acid, and (iii) a difunctional epoxide selected from an alkyl diglycidyl ether, an alkyl diglycidyl ester, or a bisphenol diglycidyl ether; a polyfunctional epoxide selected from an aliphatic triglycidyl or polyglycidyl ether or an aromatic triglycidyl or polyglycidyl ether; or a mixture of a difunctional epoxide and a polyfunctional epoxide.

The foregoing will become more apparent from the following detailed description, which proceeds with reference to the accompanying figures.

### BRIEF DESCRIPTION OF THE DRAWINGS

FIG. 1 illustrates the laminator section and rolling section for the preparation of PSA constructs as disclosed herein.

FIG. 2 illustrates a pre-cure section including a series of rollers placed in an oven chamber.

FIG. 3 illustrates the unwinding section (for reuse of the silicone and metal films) and transfer of the PSA to backing materials for the preparation of PSA constructs as disclosed herein.

### DETAILED DESCRIPTION

As used herein, the singular terms “a,” “an,” and “the” include plural referents unless context clearly indicates otherwise. Also, as used herein, the term “comprises” means “includes.”

The term “aliphatic” is defined as including alkyl, alkenyl, alkynyl, halogenated alkyl and cycloalkyl groups as described above. A “lower aliphatic” group is a branched or unbranched aliphatic group having from 1 to 10 carbon atoms.

The term “alkyl” refers to a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is a saturated branched or unbranched hydrocarbon having from 1 to 10 carbon atoms. Preferred alkyl groups have 1 to 4 carbon atoms. Alkyl groups may be “substituted alkyls” wherein one or more hydrogen atoms are substituted with a substituent such as halogen, cycloalkyl, alkoxy, amino, hydroxyl, aryl, or carboxyl.

The term “aryl” refers to any carbon-based aromatic group including, but not limited to, phenyl, naphthyl, etc. The term “aryl” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorous. The aryl group can be substituted with one or more groups including, but not limited to, alkyl, alkynyl, alkenyl, aryl, halide, nitro, amino, ester, ketone, aldehyde, hydroxy, carboxylic acid, or alkoxy, or the aryl group can be unsubstituted.

The term “cycloalkyl” refers to a non-aromatic carbon-based ring composed of at least three carbon atoms. Examples of cycloalkyl groups include, but are not limited to, cyclopropyl, cyclobutyl, cyclopentyl, cyclohexyl, and the like. The term “heterocycloalkyl group” is a cycloalkyl group as defined above where at least one of the carbon atoms of the ring is substituted with a heteroatom such as, but not limited to, nitrogen, oxygen, sulfur, or phosphorous.

“Heteroalkyl” means an alkyl group wherein at least one carbon atom of the otherwise alkyl backbone is replaced with a heteroatom, for example, O, S or N.

Prepolymers, as described herein, may be reaction product mixtures after pre-polymerization but prior to (further) polymerization and curing reaction. The reaction product mixtures can consist of polymers of a wide spectrum of molecular weights. Oligomers have a low degree of polymerization (relatively low molecular weight). Prepolymer mixtures can include or consist of oligomers.

Disclosed herein are new PSA compositions based on the reaction of epoxidized fatty acid(s), dibasic or polybasic carboxylic acid compounds, and difunctional or polyfunctional epoxides, and methods for preparing PSA formulations, PSA labels, tapes or other PSA products. In particular, the polymerization and/or curing reactions are based on the reaction of epoxy groups and carboxylic acid groups. For example, illustrative repeating units for the final product polymers in the PSA from the polymerization and/or curing reaction based on the reaction between an epoxy group and a carboxylic acid group can be represented as shown below. The repeating units (EFA, DA, and DE, etc) can be covalently linked to form ester groups in a random and/or block sequence.

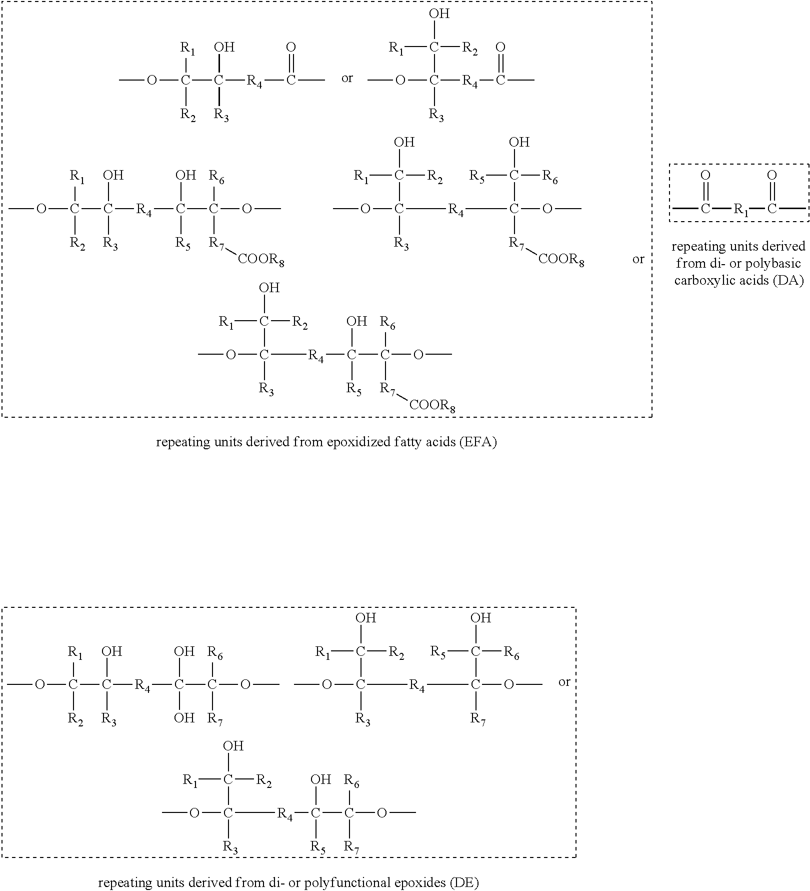

wherein each of R₁, R₂, R₃, R₄, R₅, R₆, R₇, and R₈ independently represents hydrogen, or a substituted or unsubstituted alkyl or heteroalkyl group. For example, the alkyl or heteroalkyl groups may be substituted with an aryl or heteroaryl group, or the alkyl or heteroalkyl group may be substituted with functional groups (e.g., oxirane, carboxylic acid groups).

The new PSA compositions possess low glass transition temperatures, sufficient cohesive strength, and good initial tack and adhesive powder. In addition, they are odorless and made without using organic solvents, and in most cases originate from only renewable raw materials. The chemical structure of the present compositions is particularly designed to meet the criteria for application as PSAs. The compositions generally possess glass transition temperatures below or at room temperature and have appropriate density of physical or chemical crosslinks, which render the compositions a balance between sufficient cohesive strength (“dry”) and good initial tack and adhesive power. For example, the T_{g} of the PSA compositions disclosed herein may be from −100 to 50° C., preferably from −80 to 40° C., more preferably from −50 to 30° C. It should be noted that, T_{g} of the PSAs can be fine-tuned to meet various demands of final PSA products. For example, preferred PSA for use in low peel labels will have a T_{g} of from −50 to −30° C. Preferred PSAs for use in freezer labels will have a T_{g} of from −45 to −30° C. Preferred PSAs for use in cold temperature labels will have a T_{g} of from −25 to −10° C. Preferred PSAs for use in PSA tapes will have a T_{g} of from −10 to 10° C. Preferred PSAs for use in high peel labels will have a T_{g} of from 0 to 10° C. Preferred PSAs for use in disposables will have a T_{g} of from 10 to 30° C. (see, e.g., D. R. Parikh, M. Guest, D. R. Speth. Compositions comprising a substantially random interpolymer of at least one α-olefin and at least one vinylidene aromatic monomer or hindered aliphatic vinylidene monomer, U.S. Pat. No. 6,344,515B1, 2002; “Viscoelastic properties of pressure-sensitive adhesives” by S. G. Chu (Chapter 8 of the Handbook of Pressure-sensitive Adhesive Technology, second edn, D. Satas, Ed., 1989)).

Furthermore, disclosed methods for making the PSA compositions and PSA products are characterized by a process that may include pre-polymerization and (further) polymerization and/or curing stages. Certain embodiments are characterized by a “thin-layer reactor” technology (see below for details) which facilitates making PSA products.

In particular, disclosed herein is a method for making a PSA comprising: (a) polymerizing at least one dibasic or polybasic carboxylic acid with at least one first epoxidized fatty acid (“at least one” indicates that a mixture of different epoxidized fatty acids could be used) at a stoichiometric molar excess of reactive carboxylic acid groups relative to reactive epoxy groups to produce a thermoplastic prepolymer or oligomer capped with carboxylic acid groups; and (b) curing the resulting thermoplastic prepolymer or oligomer with at least one difunctional or polyfunctional epoxide, and optionally at least one second epoxidized fatty acid or EFAs, optionally under heating, to produce a PSA, wherein the difunctional or polyfunctional epoxide is not an epoxidized vegetable oil. The second epoxidized fatty acid, which may be optionally included in step (b), may be the same composition or a different composition compared to the first epoxidized fatty acid. In some embodiments, a prepolymer is produced by polymerization (a). In other embodiments, an oligomer is produced by polymerization (a). The thermoplastic prepolymer or oligomer produced in polymerization (a) may be a mixture of linear, branched, and hyperbranched polyesters with the branches and chain ends capped with a carboxylic acid group, as well as some starting carboxylic acid compounds which may be left unreacted in some cases. By careful selection of the monomer pairs, design of the monomer feed ratio, and optimization of the reaction conditions and operations, a rich array of thermoplastic polymers or oligomers with at least two of the branches and chain ends capped with carboxylic acid groups can be obtained. The thermoplastic prepolymer or oligomer produced in polymerization (a) may have a molecular weight (number average molecular weight) of no higher than 500,000, preferably no higher than 100,000, more particularly no higher than 50,000. The curing in step (b) may include crosslinking of polymer chains and/or further polymerization (e.g. increasing chain length). A further embodiment disclosed herein is a PSA construct or article comprising: (a) a backing substrate; and (b) a PSA composition disposed on the backing substrate, wherein the PSA composition includes a polymer made by reacting the carboxylic acid-capped prepolymer or oligomer with at least one difunctional or polyfunctional epoxide, and optionally at least one second epoxidized fatty acid, optionally under heating, wherein the epoxide is not an epoxidized vegetable oil.

Disclosed herein is another method for making a PSA comprising: (a) polymerizing at least one dibasic or polybasic carboxylic acid with at least one difunctional or polyfunctional epoxide, at a stoichiometric molar excess of reactive carboxylic acid groups relative to reactive epoxy groups to produce a thermoplastic prepolymer or oligomer capped with carboxylic acid groups, wherein the difunctional or polyfunctional epoxide is not an epoxidized vegetable oil; and (b) curing the resulting thermoplastic prepolymer or oligomer with at least one epoxidized fatty acid, optionally under heating, to produce a PSA. In some embodiments, a prepolymer is produced by polymerization (a). In other embodiments, an oligomer is produced by polymerization (a). The thermoplastic prepolymer or oligomer produced in polymerization (a) may be a mixture of linear, branched, and hyperbranched polyesters with the branches and chain ends capped with a carboxylic acid group, as well as some starting carboxylic acid compounds which may be left unreacted in some cases. By careful selection of the monomer pairs, design of the monomer feed ratio, and optimization of the reaction conditions and operations, a rich array of thermoplastic polymers or oligomers with at least two of the branches and chain ends capped with carboxylic acid groups can be obtained. The thermoplastic prepolymer or oligomer produced in polymerization (a) may have a molecular weight (number average molecular weight) of no higher than 500,000, preferably no higher than 100,000, more particularly no higher than 50,000. The curing in step (b) may include crosslinking of polymer chains and/or further polymerization (e.g. increasing chain length). A further embodiment disclosed herein is a PSA construct or article comprising: (a) a backing substrate; and (b) a PSA composition disposed on the backing substrate, wherein the PSA composition includes a polymer made by reacting the carboxylic acid-capped prepolymer or oligomer with at least one epoxidized fatty acid or EFAs, optionally under heating.

Disclosed herein is still another method for making a PSA comprising: (a) polymerizing (i) at least one epoxidized fatty acid or epoxidized fatty acids mixture (EFAs) with (ii) at least one dibasic or polybasic carboxylic acid and (iii) at least one difunctional or polyfunctional epoxide, optionally under heating, to produce a thermoplastic prepolymer or oligomer, wherein the difunctional or polyfunctional epoxide is not an epoxidized vegetable oil; and (b) curing the resulting thermoplastic prepolymer or oligomer optionally under heating to produce a PSA. In some embodiments, a prepolymer is produced by polymerization (a). In other embodiments, an oligomer is produced by polymerization (a). By careful selection of the monomer pairs, design of the monomer feed ratio, and optimization of the reaction conditions and operations, a rich array of thermoplastic polymers or oligomers. The thermoplastic prepolymer or oligomer produced in polymerization (a) may have a molecular weight (number average molecular weight) of no higher than 500,000, preferably no higher than 100,000, more particularly no higher than 20,000. The curing in step (b) may include crosslinking of polymer chains and/or further polymerization (e.g. increasing chain length). A further embodiment disclosed herein is a PSA construct or article comprising: (a) a backing substrate; and (b) a PSA composition disposed on the backing substrate, wherein the PSA composition includes a polymer made by further polymerizing and/or curing of the prepolymer or oligomers produced by polymerization (a), optionally under heating.

Epoxidized Fatty Acid or Epoxidized Fatty Acids Mixture (EFAs).

In some embodiments, mixtures of epoxidized fatty acids (also referred to herein as “epoxidized fatty acids mixture” or “EFAs”) are obtained (i) via epoxidization of plant oils, marine oil, or other esters of unsaturated fatty acids, followed by saponification of the epoxidized products and acidification of the saponified products thereof, or (ii) via saponification and acidification of plant oils, marine oil, or other esters of unsaturated fatty acids to give a mixture of unsaturated fatty acids followed by epoxidization of the unsaturated fatty acids. The intermediate epoxidized products may be obtained from plant oils, marine oil, or other esters of unsaturated fatty acids by converting their double bonds into more reactive oxirane moieties. In particular embodiments, the intermediate epoxidized products generally refers to any derivative of plant oils, marine oil, or other esters of unsaturated fatty acids whose double bonds are fully or partly epoxidized using any method, e.g. so called in situ performic acid process, which is the most widely applied process in industry. Herein, “plant oil” and “marine oil” refer to a group of triglycerides which are composed of three fatty acids (at least one fatty acid is unsaturated) connected to a glycerol molecule, including but not limited plant oils, marine oils, distilled fractures of plant oils or marine oils, tall oils. Typically, the fatty acids are long chain (C₁₂ to C₂₄ or even longer) materials with one or multiple double bonds per chain. The plant oil can be palm oil, olive oil, canola oil, corn oil, cottonseed oil, soybean oil, linseed oil, rapeseed oil, castor oil, coconut oil, palm kernel oil, rice bran oil, safflower oil, sesame oil, sunflower oil, or other unsaturated plant oils (both naturally existing and genetically modified), or mixtures thereof. The marine oil can be menhaden, sardine, and herring oil, etc. Other esters of unsaturated fatty acids that can be used in the methods disclosed herein include monoglycerides and/or diglycerides of unsaturated fatty acid; unsaturated fatty acid methyl ester; animal fats like tallow, butterfat, and lard; and artificial fats like Olestra which is an artificial fat created from sucrose and fatty acids.

Saponification of (epoxidized) plant oils, marine oil, or other esters of unsaturated fatty acids can take place in the presence of sodium hydroxide or potassium hydroxide, etc. In the course of the saponification and acidification, the epoxy groups in the intermediate epoxidized products can be preserved completely under controlled reaction conditions. In some embodiments, a mixture of epoxidized fatty acids obtained via saponification of epoxidized plant oils, epoxidized marine oil, or other esters of epoxidized fatty acids are used as starting materials without further purification in the new PSA compositions. For example, the mixture of epoxidized fatty acids may include at least one of epoxidized oleic acid, epoxidized elaidic acid, epoxidized myristoleic acid, epoxidized palmitoleic acid, epoxidized sapienic acid, epoxidized vaccenic acid, epoxidized erucic acid, epoxidized ricinoleic acid, epoxidized linoleic acid (including fully and partially epoxidized linoleic acid), epoxidized linoelaidic acid (including fully and partially epoxidized linoelaidic acid), epoxidized linolenic acid (including fully and partially epoxidized linolenic acid), epoxidized α-linolenic acid (including fully and partially epoxidized α-linolenic acid) epoxidized α-eleostearic acid (including fully and partially epoxidized α-eleostearic acid), epoxidized arachidonic acid (including fully and partially epoxidized arachidonic acid), epoxidized eicosapentaenoic acid (including fully and partially epoxidized eicosapentaenoic acid), or epoxidized docosahexaenoic acid (including fully and partially epoxidized docosahexaenoic acid). The mixture of epoxidized fatty acids derived from plant oils, marine oil, or other esters of unsaturated fatty acids, may also include a small amount (e.g., ˜10 wt % based on total mixture mass) of at least one of stearic acid, lauric acid, palmitic acid.

In other embodiments, epoxidized oleic acid, epoxidized linoleic acid (including fully and partially epoxidized linoleic acid) or epoxidized linolenic acid (including fully and partially epoxidized linolenic acid) can be separated from the epoxidized fatty acid mixtures prior to their use as an ingredient for the new PSAs.

Alternatively, epoxidized oleic acid, epoxidized linoleic acid (including fully and partially epoxidized linoleic acid) or epoxidized linolenic acid (including fully and partially epoxidized linolenic acid) can be obtained by alkanolysis (e.g., methanolysis) of the plant oils, marine oil, or other esters of unsaturated fatty acids to give alkyl oleate, linoleate or linolenate, etc., followed by epoxidization and saponification of the alkyl esters thereof, and acidification of the saponified products thereof, or by hydrolysis of the plant oils, marine oil, or other esters of unsaturated fatty acids to give oleic, linoleic or linolenic acid, etc., followed by epoxidization of unsaturated fatty acids thereof. Illustrative alkyl esters of the fatty acid include methyl, propyl or ethyl esters.

Dibasic or Polybasic Carboxylic Acid Compounds.

The dibasic or polybasic acids used in the preparation of the PSAs may include any compound that contains at least two carboxylic acid functional groups, and derivatives or analogs thereof. Compounds that include at least two displaceable active hydrogen atoms per molecule but the hydrogen atoms are not part of a carboxylic acid moiety are also considered to be dibasic acids from the viewpoint of polycondensation chemistry. For example, the “displaceable active hydrogen atoms” can be part of hydroxyl groups (—OH), amine groups (—NHR and —NH₂), or thiol groups (—SH), sulfonamides, etc. More than one dibasic acid can be utilized in a single mixture if desired.

Dibasic or polybasic acids can be aliphatic (linear, branch or cyclic) saturated carboxylic acids containing up to 100 carbon atoms, preferably 2 to 60 carbon atoms, and more preferably 2 to 22 carbon atoms, e.g., oxalic acid, malonic acid, itaconic acid, succinic acid, glutaric acid, adipic acid, pimelic acid, suberic acid, azelaic acid, sebacic acid, brassylic acid, and docosanedioic acid. Dibasic or polybasic acids may also be aromatic acids and derivatives thereof, including without limitation, phthalic acid, isophthalic acid and terephthalic acid. Dibasic or polybasic acid can also be produced from other derivatives such as anhydrides. Specific examples include without limitation succinic anhydride, itaconic anhydride, and phthalic anhydride. From the viewpoint of polycondensation chemistry, tribasic or higher H-functionality acids can also be considered to be “dibasic or polybasic acids”. Tribasic or higher H-functionality acids include without limitation, 1,2,3,4-butanetetracarboxylic acid, ethylenediamine tetraacetic acid, citric acid, trimellitic acid, trimellitic anhydride, trimer acids, polymerized fatty acids, etc. Those obtained or derived from renewable raw materials are preferred, e.g., dimer acid, trimer acids, polymerized fatty acids, and citric acid. Citric acid is a tribasic organic acid, existing in a variety of fruits and vegetables, most notably citrus fruits. It is a commodity chemical produced and consumed throughout the world; the global production of citric acid in 2007 was over 1.6 million tons, and the world demand is still in rapid increasing (see, e.g., “citric acid production” by M. Berovic and M. Legisa (Biotechnol. Annu. Rev. 2007).

The dibasic or polybasic carboxylic acids or anhydride derivatives are preferably derived from natural resources. In addition to the high energy-consuming traditional processes for the production of dibasic acids, alternative accesses to various dibasic acids from renewable feedstocks have been well reported (see, e.g, “Lipids as renewable resources: current state of chemical and biotechnological conversion and diversification” by J. O. Metzger and U. Bornscheuer (Appl. Microbiol. Biotechnol. 2006)). For example, illustrative dibasic acids from natural renewable resources include a dimer acid, a trimer acid, and/or a polymerized fatty acid. These compounds may contain two or more carboxylic acid functional groups per molecule, which include without limitation, dimer acids, trimer acids, polymerized fatty acids (including their saturated forms obtained via hydrogenation), or mixtures thereof. Dimer acids, or dimerized fatty acids, are dicarboxylic acids that may be prepared by dimerizing unsaturated fatty acids, usually on clay catalysts (e.g., montmorillonite clay). Likewise, trimer acids and polymerized fatty acids are corresponding products where the resulting molecules consist of three and more fatty acid molecules, respectively. Although trimer acids and polymerized fatty acids consist of three and more carboxylic acid groups, respectively, they can also be considered to be “dibasic acids” from the viewpoint of polycondensation chemistry. Tall oil fatty acids (consisting mainly of oleic and linoleic acids) and other fatty acids from vegetable oils (e.g., erucic acid, linolenic acid), marine oils or tallow (e.g., high oleic tallow) can be starting materials to prepare dimer acids, trimer acids and polymerized fatty acids or mixtures thereof. (see, e.g, “Preparation of Meadowfoam Dimer Acids and Dimer Esters and Their Use as Lubricants” by D. A. Burg and R. Kleiman (JAOCS. 1991), “Fats and oils as oleochemical raw materials” by K. Hill (Pure Appl. Chem. 2000)). The fact that “dibasic acids” like dimer acids, trimer acids or polymerized fatty acids can be produced or derived from vegetable oil means that the PSA composition may be made entirely from renewable sources.

In certain embodiments, the dimer acid is a dimer of an unsaturated fatty acid or a mixture of the dimer and a small amount (up to 10, or 20, weight percent) of a monomer or trimer of the unsaturated fatty acid. The trimer acid is a trimer of an unsaturated fatty acid or a mixture of the trimer and a small amount (up to 10 weight percent) of a monomer or dimer of the unsaturated fatty acid. A polymerized fatty acid contains four or more unsaturated fatty acid residues. The dimer acid, trimer acid or polymerized fatty acid may be a mixture of dimerized, trimerized or polymerized unsaturated fatty acids. Preferable unsaturated fatty acids include carboxylic acids having 12 to 24 carbon atoms and at least one unsaturated bond per molecule. Preferable acids having one unsaturated bond include, for example, oleic acid, elaidic acid and cetoleic acid. Preferable fatty acids having two unsaturated bonds include sorbic acid and linoleic acid. Preferable fatty acid having three or more of unsaturated bonds include linoleinic acid and arachidonic acid. The dimer acid, trimer acid, or polymerized fatty acid may be partially or fully hydrogenated. Illustrative dimer acids have the structure:

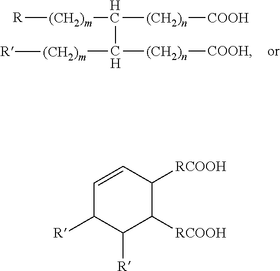

where R and R′ are the same or different, saturated, unsaturated or polyunsaturated, straight or branched alkyl groups having from 1 independently to 30 carbon atoms, and n, m, n′ and m′ are the same or different, ranging from 0 to 20. There may be more than one C—C crosslink between the monofunctional carboxylic acid moieties. Alternatively, R and R′ are the same or different, saturated, unsaturated or polyunsaturated, straight alkyl groups having from 1 independently to 20 carbon atoms, or having from 1 independently to 8 carbon atoms; n and m are the same or different, ranging from 1 independently to 10, or ranging from 4 independently to 16. In other non-limiting embodiments R may be butyl and R′ may be octyl; n may be 8 and m may be 14.

In another embodiment, the dimer acid may have the definition found in U.S. Pat. No. 3,287,273, incorporated herein in its entirety by reference. Such commercial dimer acids are generally produced by the polymerization of unsaturated C₁₈ fatty acids to form C₃₆ dibasic dimer acids. Depending on the raw materials used in the process, the C₁₈ monomeric acid may be linoleic acid or oleic acid or mixtures thereof. The resulting dimer acids may therefore be the dimers of linoleic acid, oleic acid or a mixture thereof.

Illustrative dimer acids include:

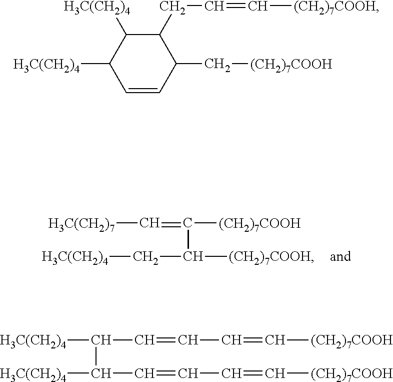

The structure of the trimer acids and polymerized fatty acids include three and more unsaturated fatty acid residues. They can be reaction products between unsaturated fatty acids, dimer acids thereof, and/or trimer acids and polymerized fatty acids thereof, via Diels-Alder and/or radical mechanism.

Difunctional or Polyfunctional Epoxides.

Epoxides used in the preparation of the PSAs disclosed herein may include any compound that contains at least two oxirane or epoxy functional groups, and derivatives or analogs thereof. More than one epoxide can be utilized in a single reaction mixture if desired. Epoxides can be glycidyl-containing compounds or epoxidized compounds having at least two epoxy groups. Examples of glycidyl-containing compounds include aliphatic diglycidyls such as an alkyl diglycidyl ether or an alkyl diglycidyl ester, or aromatic diglycidyls such as bisphenol diglycidyl ether. Examples of epoxides include without limitation, bisphenol A diglycidyl ether, bisphenol A ethoxylate diglycidyl ether, bisphenol A propoxylate diglycidyl ether, bisphenol F diglycidyl ether, bisphenol F ethoxylate diglycidyl ether, bisphenol F propoxylate diglycidyl ether, ethylene glycol diglycidyl ether, diethylene glycol diglycidyl ether, poly(ethylene glycol) diglycidyl ether, propylene glycol diglycidyl ether, dipropylene glycol diglycidyl ether, poly(propylene glycol) diglycidyl ether, 1,3-butanediol diglycidyl ether, 1,4-butanediol diglycidyl ether, neopentyl glycol diglycidyl ether, glycerol diglycidyl ether, diglycidyl 1,2,3,6-tetrahydrophthalate, 1,2-cyclohexanedicarboxylate diglycidyl ether, dimer acid diglycidyl ester, 1,4-cyclohexanedimethanol diglycidyl ether, 3,4-epoxycyclohexylmethyl 3,4-epoxycyclohexanecarboxylate, resorcinol diglycidyl ether, poly(dimethylsiloxane) terminated with diglycidyl ether, and epoxidized fatty acid esters having two epoxy functional groups like epoxidized linoleic acid ester. In certain embodiments, compounds having more than two epoxy-functionalities are also considered to be difunctional epoxides from the viewpoint of polycondensation chemistry, which include without limitation, trimethylolpropane triglycidyl ether, trimethylolethane triglycidyl ether, N,N-diglycidyl-4-glycidyloxyaniline, 4,4′-methylene bis(N,N-diglycidylaniline), tris(4-hydroxyphenyl)methane triglycidyl ether, tris(2,3-epoxypropyl) cyanurate, tris(2,3-epoxypropyl) isocyanurate, epoxidized polybutadiene, epoxidized fatty acid esters having more than two epoxy functional groups like epoxidized linolenic acid ester, etc.

In certain embodiments, the EFAs, dibasic or polybasic carboxylic acid compounds, and the difunctional or polyfunctional epoxides can all be obtained or derived from natural resources making the presently disclosed compositions entirely renewable PSAs.

The reaction mixtures can also contain from about 0.05 to 10.0, more particularly 0.1 to 10.0, preferably from about 0.1 to 2 parts by weight of a catalyst, based on the weight of the reactants, especially when the reaction is performed at low temperatures (e.g., <120° C.). The catalysts accelerate the polymerizations of epoxides with dibasic or polybasic acids, and reduce the cure time of the thermoplastic epoxy resins in the presence of curing agents. Catalysts used to effectively catalyze the reaction between carboxylic acid groups or anhydride groups and epoxy groups can be employed for this purpose:

(1) amines, especially tertiary amines,—examples include but are not limited to, triethylamine, trimethylamine, tri-n-pentylamine, trioctylamine, tridecylamine, tridodecylamine, trieicosylamine, docosyldioctylamine, triacontyldibutylamine, 2-ethylhexyl di-n-propylamine, isopropyl di-n-dodecylamine, isobutyl di-n-eicosylamine, 2-methyldocosyl di-(2-ethylhexyl) amine, triacontyl di-(2-butyldecyl) amine, n-octadecyl di-(n-butyl)amine, n-eicosyl di-(n-decyl)amine, n-triacontyl n-dodecylmethylamine, n-octyldimethylamine, n-decyldiethylamine n-dodecyldiethylamine, n-octadecyldimethylamine, n-eicosyl dimethylamine, n-octyl n-dodecylmethylamine, n-decyl n-eicosylethylamine, n-octyldimethylamine, n-decyldimethylamine, n-dodecyldimethylamine, n-tetradecyldimethylamine, n-hexadecyldimethylamine, n-octadecyldimethylamine, n-eicosyldimethylamine, di-(n-octyl)methylamine, di-(n-decyl)methylamine, di-(n-dodecyl)methylamine, di-(n-tetradecyl)methylamine, di-(n-hexadecyl)methylamine, di-(n-octadecyl)methylamine, di-(n-eicosyl)methylamine, n-octyl n-dodecylmethylamine, n-decyl n-octadecylmethylamine, dimethylbenzylamine, N,N-dimethylaniline, N,N-dimethylaniline, N-methyldiphenylamine, triphenylamine, N-methyl-N-dodecylaniline pyridine, 2-methylpyridine, triethanolamine, N-methylmorpholine, N-methylpiperidine, N-ethylpiperidine, N,N-dimethylpiperazine, 1-methyl imidazole, 1-butylimidazole, 1,8-diazabicyclo[5.4.0]undec-7-ene, 1,5-diazabicyclo[5.4.0]undec-5-ene, 1,5-diazabicyclo[4.3.0]non-5-ene, 1,4-diazobicyclo[2.2.2]-octane, tetramethyl guanidine, N,N,N′,N′-tetramethyl-1,8-diaminonaphthalene, 2-phenyl-2-imidazoline, 2-ethylimidazole, bis(2-ethylhexyl)amine, etc;

(2) metal salts or complexes,—examples include but are not limited to, chromium (III) tris(acetylacetonate), chromium (III) 2-ethylhexanoate, AFC Accelerator AMC-2 (a 50 wt % solution of chromium (III) complex available from Ampac Fine Chemical LLC), HYCAT (based on an activated oxo-centered-trinuclear chromium (III) complex available from Dimension Technology Chemical Systems, Inc.), chromium (III) hexanoate, chromium (III) octoate, chromium (III) stearate, chromium (III) naphthenate, 3,5-diisopropylsalicylato chromium (III) chelate, bis(3,5-diisopropylsalicylato)-monohydroxy chromium (III) chelate, zinc acetate, zinc acetate dihydrate, zinc acetylacetonate, zinc octoate, zinc laurate, zinc salicylate, zinc glycinate, zinc gluconate, zinc oleoylsarcosinoate, zinc naphthenate, zinc 2-ethylhexyl acid phosphate salt, zinc butyl acid phosphate salt, zinc di-2-ethylhexyldithio-phosphate, zinc salt of dodecenyl succinate butyl half ester, N-butylsalicylaldimio zinc (II) chelate, zinc isovalerate, zinc succinate, zinc dibutyl dithiocarbamate, Nacure XC-9206 (a zinc (II) complex from King Industries, Inc.), stannous octoate, stannum (II) 2-ethylhexyl acid phosphate salt, titanium ethyl acetoacetate chelate, titanium acetoacetate chelate, titanium triethanolamine chelate, zirconium octoate, zirconium 6-methylhexanedione, zirconium (IV) trifluoroacetylacetone, 3,5-diisopropylsalicylato nickel (II) chelate, nickel acetylacetonate, N-butylsalicylaldimio nickel (II) chelate, 3,5-diisopropylsalicylato manganese (II) chelate, manganese naphthenate, manganese naphthenate, magnesium 2,4-pentadionate, iron octoate, ferric linoleate, iron (III) acetylacetonate, cobalt octoate, cobalt naphthenate, cobalt (III) acetylacetonate, N-butylsalicylaldimio cobalt (II) chelate, N-butylsalicylaldimio cobalt (III) chelate, 3,5-diisopropylsalicylato cobalt (II) chelate, N-butylsalicylaldimio copper (II) chelate, 3,5-diisopropylsalicylato copper (II) chelate, 3,5-diisopropylsalicylato oxyvanadium (IV) chelate, aluminum acetylacetonate, aluminum lactate, dibutyltin dilaurate, dibutyltin oxide, butylchloro tin dihydroxide, cerium naphthenate, calcium octoate, bismuth octoate, lithium acetate, sodium acetate, potassium acetate, etc;

(3) quaternary ammonium compounds,—examples include but are not limited to, tetrabutyl ammonium bromide, tetrabutyl ammonium iodide, tetrabutyl ammonium hydrogen sulphate, tetrabutyl ammonium fluoride, tetrabutyl ammonium chloride, tetraethyl ammonium bromide, tetraethylammonium iodide, tetrapropylammonium bromide, tetrapropyl ammonium iodide, tetramethyl ammonium chloride, tetramethylammonium bromide, tetramethyl ammonium iodide, tetraoctyl ammonium bromide, benzyltriethyl ammonium chloride, benzyltributyl ammonium chloride, benzyltrimethyl ammonium chloride, benzyltrimethylammonium bromide, butyltriethyl ammonium bromide, methyltrioctyl ammonium chloride, methyltricapryl ammonium chloride, methyltributyl ammonium chloride, methyltributyl ammonium bromide, methyltriethyl ammonium chloride, myristyltrimethyl ammonium bromide, tetradecyltrimethyl ammonium bromide, cetyltrimethyl (or hexadecyltrimethyl) ammonium bromide, hexadectyltrimethyl ammonium bromide, cetyltrimethylammonium chloride, hexadectyltrimethyl ammonium chloride, lauryltrimethyl ammonium chloride, dodecyltrimethyl ammonium chloride, phenyltrimethyl ammonium chloride, benzalkonium chloride, cetyldimethylbenzyl ammonium bromide, cetalkonium bromide, cetyldimethylbenzyl ammonium chloride, cetalkonium chloride, tetrabutyl ammonium perchlorate, tetrabutyl ammonium p-toluene sulfonate, tetraethyl ammonium p-toluene sulfonate, cetyltrimethyl ammonium p-toluene sulfonate, tetraethyl ammonium tosylate, tetrabutyl ammonium tosylate, cetyltrimethyl ammonium tosylate, phenyltrimethyl ammonium bromide, benzyltrimethyl ammonium hydroxide, tetrabutyl ammonium hydroxide, tetramethyl ammonium hydroxide, etc;

(4) quaternary phosphonium compounds,—examples include but are not limited to, tetrabutyl phosphonium bromide, ethyltriphenyl phosphonium iodide, ethyltriphenyl phosphonium bromide, ethyltriphenyl phosphonium iodide, butyltriphenyl phosphonium bromide, benzyltriphenyl phosphonium chloride, methyltriphenyl phosphonium bromide, methyltriphenyl phosphonium iodide, tetraphenyl phosphonium bromide, triphenyl phosphonium bromide, methyltriphenyl phosphonium chloride, butyl triphenyl phosphonium chloride, (methoxy methyl)triphenyl phosphonium chloride, etc;

(5) phosphines, examples include but are not limited to, triphenylphosphine, etc;

(6) alkali metal hydroxide, e.g. potassium hydroxide, sodium hydroxide, etc.

The catalysts may be added at any point during the polymerization from the initial charge until the coating of the reaction mixtures. In certain embodiments, it is preferred and important that the catalyst be dissolved in one of the reactants, preferably in dibasic or polybasic acids, prior to the polymerization.

In particular embodiments, the final polymerization products (i.e., the final cured epoxy polymers) disclosed herein are the majority component of the PSA composition meaning the PSA composition includes at least about 50, particularly at least about 70, more particularly at least about 80, and most particularly at least about 90, weight percent of the cured epoxy polymers based on the total weight of the PSA composition. The PSA compositions may also include fillers and additives to improve peel, tack and cohesion properties, etc. Fillers may either originally occur in the starting materials such as esters of fatty acids, or be added as needed. Additives such as tackifiers, colored pigments, opacifiers, processing oils, plasticizers, solvents and other constituents known to the tape art may be incorporated in the PSAs.

In one embodiment, various thermoplastic prepolymers or oligomers capped with carboxylic acid groups are first prepared via polymerization of dibasic or polybasic carboxylic acids with at least one epoxidized fatty acid or epoxidized fatty acids mixture (EFAs), at a stoichiometric molar excess of reactive carboxylic acid groups relative to reactive epoxy groups. These polymerizations can be carried out at a temperature suitably in the range from 20 to 300° C. for 1 to 300 minutes, preferably from 60 to 220° C. for 2 to 240 minutes, and more particularly from 80 to 180° C. for 5 to 180 minutes, to a degree that the epoxy groups are virtually completely consumed. Complete consumption of epoxy groups can be confirmed, e.g., by checking the disappearance of characteristic signal (at ca 850-820 cm⁻¹) for the epoxy groups in the FTIR spectrum. If desired, the reactions are preferably carried out under an inert atmosphere free from oxygen (e.g., under nitrogen). The molar ratio of carboxylic acid groups to epoxy or oxirane groups (C/E) in the reaction feed is important to the polymerizations, since it governs the nature of the terminal monomeric units, crosslink density (if any), molecular weight and viscosity of the resulting prepolymers. The molar ratio C/E should be higher than 1.0, particularly higher than 1.1, more particularly 1.2, and preferably from 1.1 to 100, more particularly from 1.02 to 50, to ensure that the resulting prepolymers or oligomers are thermoplastic and capped with at least two carboxylic acid groups per molecule.

Illustrative repeating units for the prepolymers or oligomers from the polymerization based on the reaction between an epoxy group and a carboxylic acid group can be represented as described as follows. The repeating units (EFA and DA) can be covalently linked to form ester groups in a random sequence.

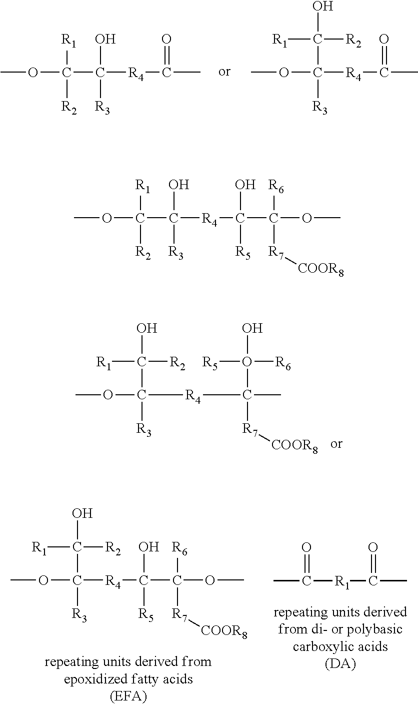

wherein each of R₁, R₂, R₃, R₄, R₅, R₆, R₇, and R₈ independently represents hydrogen, or a substituted or unsubstituted alkyl or heteroalkyl group. For example, the alkyl or heteroalkyl groups may be substituted with an aryl or heteroaryl group, or the alkyl or heteroalkyl group may be substituted with functional groups (e.g., oxirane, carboxylic acid groups).

The resulting prepolymers or oligomers are grafted and/or terminated with carboxylic acid group containing terminal units which can be illustrated as

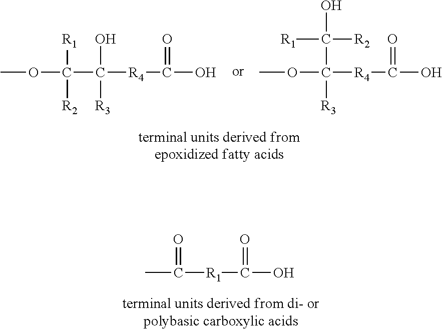

wherein each of R₁, R₂, R₃, and R₄ independently represents hydrogen, or a substituted or unsubstituted alkyl or heteroalkyl group. For example, the alkyl or heteroalkyl groups may be substituted with an aryl or heteroaryl group, or the alkyl or heteroalkyl group may be substituted with functional groups (e.g., oxirane groups).

After the non-stoichiometrically-balanced polymerization, the thermoplastic prepolymers or oligomers capped with carboxylic acid groups further react with at least one difunctional or polyfunctional epoxide (and optionally at least one epoxidized fatty acid) at a temperature suitably in the range from 20 to 300° C. for 1 to 180 minutes, preferably from 40 to 220° C. for 2 to 120 minutes, and more particularly from 60 to 180° C. for 3 to 60 minutes, to a degree that cross-linking does not obviously occur, and the viscosity of the intermediate reaction mixture is appropriate for coating. If desired, the reactions are preferably carried out under an inert atmosphere free from oxygen, e.g., under nitrogen. The mixture compositions may have an open time of up to about 5 to 360 minutes, depending on the nature of the carboxylic acids and epoxides, the molar ratio of carboxylic acid groups to epoxy or oxirane groups, the viscosity and functionality density of the reaction mixture, reaction temperature, and the nature and amount of catalysts used, etc. As used herein, “open time” denotes the time from mixing the thermoplastic epoxy resins with difunctional or polyfunctional epoxides (and optionally at least one epoxidized fatty acid) to the time at which cross-linking takes place and viscosity greatly increases to a point that the mixed composition can no longer be spread. Difunctional or polyfunctional epoxides (and optionally at least one epoxidized fatty acid) can be used in a molar ratio of the epoxy groups to the carboxylic acid groups present in the resulting mixture of from about 3:1 to about 1:3, preferably from 1.5:1 to 1:1.5, more particularly from 1.1:1 to 1:1.1. The “resulting mixture” in the preceding sentence refers to the mixture obtained by admixing the thermoplastic carboxylic acid-capped prepolymers or oligomers from step (a) with difunctional or polyfunctional epoxides and optionally epoxidized fatty acid or epoxidized fatty acids mixture. Generally, the nature of the carboxylic acids, epoxides and epoxidized fatty acid(s), the molar ratio of carboxylic acid groups to epoxy groups, and/or reaction conditions can be optimized to obtain compositions with appropriate density of cross-linking which are appropriate for a PSA.

In another embodiment, various thermoplastic prepolymers or oligomers capped with carboxylic acid groups are first prepared via polymerization of dibasic or polybasic carboxylic acids with at least one difunctional or polyfunctional epoxide, at a stoichiometric molar excess of reactive carboxylic acid groups relative to reactive epoxy groups. These polymerizations can be carried out at a temperature suitably in the range from 20 to 300° C. for 1 to 300 minutes, preferably from 60 to 220° C. for 2 to 240 minutes, and more particularly from 80 to 180° C. for 5 to 180 minutes, to a degree that the epoxy groups are virtually completely consumed. Complete consumption of epoxy groups can be confirmed, e.g., by checking the disappearance of characteristic signal for the epoxy groups in the FTIR spectrum. If desired, the reactions are preferably carried out under an inert atmosphere free from oxygen (e.g., under nitrogen). The molar ratio of carboxylic acid groups to epoxy or oxirane groups (C/E) in reaction feed is important to the polymerizations, since it governs the nature of the terminal monomeric units, crosslink density (if any), molecular weight and viscosity of the resulting prepolymers. The molar ratio C/E should be higher than 1.0, particularly higher than 1.1, more particularly 1.2, and preferably from 1.1 to 100, more particularly from 1.02 to 50, to ensure that the resulting prepolymers or oligomers are thermoplastic and capped with at least two carboxylic acid groups per molecule. Illustrative repeating units for the prepolymers or oligomers from the polymerization based on the reaction between an epoxy group and a carboxylic acid group can be represented as described as follows. The repeating units (DA and DE, etc) can be covalently linked to form ester groups in a random sequence.

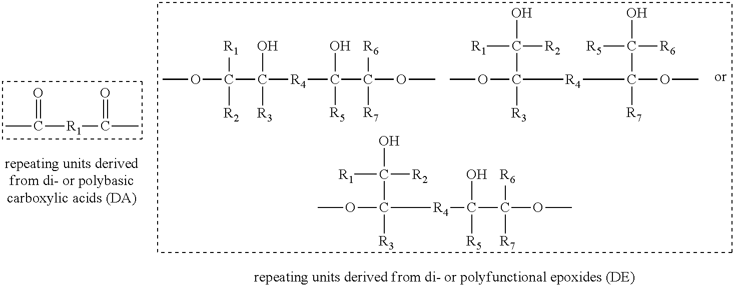

wherein each of R₁, R₂, R₃, R₄, R₅, R₆, and R₇ independently represents hydrogen, or a substituted or unsubstituted alkyl or heteroalkyl group. For example, the alkyl or heteroalkyl groups may be substituted with an aryl or heteroaryl group, or the alkyl or heteroalkyl group may be substituted with functional groups (e.g., carboxylic acid group).

The resulting prepolymers or oligomers are grafted and/or terminated with carboxylic acid group containing terminal units which can be illustrated as

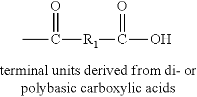

wherein R₁ represents hydrogen, or a substituted or unsubstituted alkyl or heteroalkyl group. For example, the alkyl or heteroalkyl groups may be substituted with an aryl or heteroaryl group, or the alkyl or heteroalkyl group may be substituted with functional groups (e.g., carboxylic acid group).

After the non-stoichiometrically-balanced polymerization, the thermoplastic prepolymers or oligomers capped with carboxylic acid groups further react with at least one epoxidized fatty acid or epoxidized fatty acids mixture (EFAs) at a temperature suitably in the range from 20 to 300° C. for 1 to 240 minutes, preferably from 40 to 220° C. for 2 to 160 minutes, and more particularly from 60 to 180° C. for 3 to 90 minutes, to a degree that cross-linking does not obviously occur, and the viscosity of the intermediate reaction mixture is appropriate for coating. If desired, the reactions are preferably carried out under an inert atmosphere free from oxygen, e.g., under nitrogen. The mixture compositions may have an open time of up to about 5 to 480 minutes, depending on the nature of the carboxylic acids and epoxides, the molar ratio of carboxylic acid groups to epoxy or oxirane groups, the viscosity and functionality density of the reaction mixture, reaction temperature, and the nature and amount of catalysts used, etc. As used herein, “open time” denotes the time from mixing the thermoplastic prepolymers or oligomers with the epoxidized fatty acid or EFAs to the time at which cross-linking takes place and viscosity greatly increases to a point that the mixed composition can no longer be spread. Epoxidized fatty acid or EFAs can be used in a molar ratio of the epoxy groups to the carboxylic acid groups present in the resulting mixture thus obtained of from about 3:1 to about 1:3, preferably from 1.5:1 to 1:1.5, more particularly from 1.1:1 to 1:1.1. Generally, the nature of the carboxylic acids, epoxides and epoxidized fatty acid(s), the molar ratio of carboxylic acid groups to epoxy groups, and/or reaction conditions can be optimized to obtain compositions with appropriate density of cross-linking which are appropriate for a PSA.

In still another embodiment, various thermoplastic prepolymers or oligomers are first prepared via polymerization of (i) at least one epoxidized fatty acid or epoxidized fatty acids mixture (EFAs) with (ii) at least one dibasic or polybasic carboxylic acid and (iii) at least one difunctional or polyfunctional epoxide, at a molar ratio of carboxylic acid groups to epoxy groups present in the resulting reaction mixture of from about 3:1 to about 1:3, preferably from 1.5:1 to 1:1.5, more particularly from 1.1:1 to 1:1.1, wherein the content of the epoxidized fatty acid(s) is from 5 to 95%, preferably from 20 to 85%, and more particularly from 30 to 75% based on the total weight of the reactants. These polymerizations can be carried out at a temperature suitably in the range from 20 to 300° C. for 1 to 480 minutes, preferably from 60 to 220° C. for 2 to 360 minutes, and more particularly from 80 to 180° C. for 5 to 240 minutes, to a degree that cross-linking does not obviously occur, and the viscosity of the intermediate reaction mixture is appropriate for coating. If desired, the reactions are preferably carried out under an inert atmosphere free from oxygen, e.g., under nitrogen. The mixture compositions may have an open time of up to about 5 to 720 minutes, depending on the nature of the carboxylic acids, epoxides and epoxidized fatty acid(s), the molar ratio of carboxylic acid groups to epoxy or oxirane groups, the viscosity and functionality density of the reaction mixture, reaction temperature, and the nature and amount of catalysts used, etc. As used herein, “open time” denotes the time from mixing the reaction mixture to the time at which cross-linking takes place and viscosity greatly increases to a point that the mixed composition can no longer be spread. Generally, the nature of the epoxidized fatty acid(s), carboxylic acids and epoxides, the molar ratio of carboxylic acid groups to epoxy groups, and/or reaction conditions can be optimized to obtain compositions with appropriate density of cross-linking which are appropriate for a PSA.

In some embodiments, the dibasic or polybasic carboxylic acid, the thermoplastic prepolymers or oligomers capped with carboxylic acid groups, the difunctional or polyfunctional epoxides, and/or epoxidized fatty acid or epoxidized fatty acids mixture (EFAs), and optionally the catalyst, can be mixed well in a suitable solvent or mixed solvents before spreading or coating on a liner or backing material (see below for details). In other embodiments, the reactants and optionally the catalyst are mixed well at elevated temperatures. The polymerizations are allowed to take place to a desirable extent that the reaction mixtures turn homogenous, cross-linking does not obviously occur (i.e., within the open time of the reaction mixture), and the viscosity of the mixtures is appropriate to allow coating or spreading onto release liners (e.g., siliconized release liners) or PSA backing materials. For example, the viscosity should be no higher than 2,000,000 mPa·s, preferably no higher than 200,000 mPa·s, more particularly no higher than 100,000 mPa·s, at operating temperatures. The PSA backing materials can be paper, cellophane, plastic film (e.g., poly(ethylene terephthalate) (PET) film, bi-axially oriented polypropylene(BOPP) film, polyvinylchloride (PVC) film), cloth, tape or metal foils. Generally, the reaction mixtures can be coated immediately after mixed well on siliconized release liners or PSA backing substrates with the aid of any apparatus including but not limited to a coater, to afford a thin, uniform coating of the reaction mixtures on the backing materials or liners at a coating level of about 0.5 to about 10 mg/cm². However, in some particular embodiments, in order to increase the viscosity of the reaction mixtures for good coatability, pre-polymerizations of the reaction mixtures are allowed to take place prior to coating to a desirable degree such that an appropriate viscosity of the mixture is reached but cross-linking does not obviously occur.

The resulting coated compositions on the liners or backing materials are then heated such as in an air-circulating oven, infrared oven, or tunnel oven so that further polymerization and cross-linking of the reaction mixture can take place to give a “dry” and stable adhesive layer of sufficient cohesion strength, good initial tack and adhesive power that are appropriate for PSA applications. According to some particular embodiments, the resulting adhesive coatings on the PSA backings are subjected to heat such as in an air-circulating oven maintained at 100-300° C. for 10 seconds to 400 minutes, preferably at 120-250° C. for 30 seconds to 200 minutes, and more particularly at 150-200° C. for 1 to 200 minutes. Generally, the higher the reaction temperature the shorter the duration of heating is needed to accomplish the curing reaction. However, it should be noted that the heat stability of the PSA backing or siliconized release liners should be considered before choosing the oven temperature. On the other hand, at higher temperatures, both epoxy groups and hydroxyl groups derived from the carboxylic acid-epoxy reaction may react with carboxylic acid or epoxy groups. As the curing reaction proceeds further, the by-reactions such as carboxylic acid-hydroxyl esterification reaction may dominate the reaction, with the result that the density of cross-linking increases and the resulting composition becomes less appropriate for PSA application. Although cross-linking is desirable for PSA applications, particularly where it is desired to increase the cohesive strength of the adhesive without unduly affecting its compliance, too high density of cross-linking can be deleterious to the PSA properties, with a severe loss of compliance as reflected in the peel test. Therefore, the reaction temperature at this stage should be finely tuned for appropriate cross-linking of the PSA compositions.

In particular embodiments, the PSA compositions can be coated on a release liner and covered with a sheet of backing material, resulting in a sandwich assembly which is then pressed (e.g., with a rubber roller or laminator) to achieve sufficient wet-out of the adhesive onto the PSA backing. Subsequently, the release liner is removed from the sandwich assembly, with the adhesive transferring onto the PSA backing. The resulting adhesive coatings on the backing are then heated such as in an air-circulating oven so that appropriate cross-linking of the thermoplastic epoxy resin can take place to give a dry adhesive layer of sufficient cohesion strength, good initial tack and adhesive power that are appropriate for a PSA. It should be noted that, the coating composition layer on the backing substrate after heating might not have a good appearance, with voids of adhesive on the backing substrate, probably due to shrinkage of the adhesive composition during the polymerization and curing reaction. To address this problem, a “thin-layer reactor” technology was developed and applied to the PSA systems. The pre-polymerization mixture is coated on the siliconized face of a siliconized release liner; the coating on the siliconized release liners is then covered with a sheet of PSA backing material or another sheet of release liner, resulting in the sandwich assembly functioning as “thin-layer reactor”.

In some particular embodiments, the sandwich assembly consisting of a release liner and the backing material as a whole may be heated to cure the PSA composition and then the release liner may be removed. In other particular embodiments, the preparation of a PSA composition and PSA products comprising the composition could be performed with the aid of two siliconized release liners with different adhesion-repellence (release) ability to the final adhesive composition. The pre-polymerization mixture is initially coated on the siliconized face of a sheet of partially siliconized release liner; the resulting adhesive coating is then mated with a sheet of fully siliconized release liner (with the siliconized face inwardly), resulting in a sandwich assembly which is pressed (e.g., with a rubber roller or laminator) to achieve a good contact between the adhesive composition and the two liners. A “partially” siliconized release liner means that the release liner surface is partially covered by a silicone agent; a “fully” siliconized release liner means that the release liner surface is substantially covered by a silicone agent, leading to better adhesion-repellence ability to the adhesive composition than “partially” siliconized release liner. The sandwich assembly is then heated such as in an air-circulating oven so that appropriate cross-linking of the polymers can take place to give a dry adhesive layer of sufficient cohesion strength, good initial tack and adhesive power that are appropriate for PSA application. Afterwards, the fully siliconized release liner is quickly peeled off without taking away any adhesive composition, followed by mating a sheet of backing material such as paper, PET, BOPP or PVC film on the adhesive layer. The new “sandwich” is then pressed (e.g., with a rubber roller) to achieve sufficient wet-out of the adhesive onto the backing material in order to provide adequate adhesion. After the sandwich assembly is cooled down, the partially siliconized release liner could be easily peeled off with the adhesive composition completely transferring to the backing material. In these embodiments, a first release liner, e.g., the partially siliconized release liner has an adhesion-repellence to the final adhesive composition less than that of a second release liner, e.g., the fully siliconized release liner. In other words, the second release liner can be more easily removed than the first release liner meaning that one release liner can be removed while the PSA composition still adheres to another release liner. The siliconized released liner can be optionally left for protection of the adhesive layers on the backing material. Advantages for this technology include without limitation, (1) shrinkage of the PSA composition can be considerably avoided, (2) low molecular weight starting materials for making the PSA composition are avoided to penetrate the paper backing to give oily or dirty appearance of the resulting PSA tape, and (3) in the cases that materials of low Heat Distortion Temperature and/or inferior thermal stability (such as PP and PVC) are used as PSA backing materials, subjection to oven heating at high temperatures (e.g., 160° C.) can be avoided.

To improve the production efficiency, the resulting sandwich assemblies which consist of a PSA ingredients sandwiched between a release liner and the backing material or between two liners with different release ability, can be mated with a metal film (such as thin steel film). The metal film increases the transfer efficiency of heat that is utilized for the PSA-forming reactions to take place. For example, at least one of the liner(s) or backing material has a first surface facing the PSA ingredients and a second, opposing, surface facing away from the PSA ingredients. A metal film may be disposed in contact with the second surface of at least one of the liner(s) or backing material. In certain embodiments, a metal film is disposed in contact with the second surface of a first liner or backing material to provide a layered assembly of metal film/first liner or backing material/PSA ingredients/second liner or backing material. In certain embodiments, a first metal film is disposed in contact with the second surface of a first liner or backing material, and a second metal film is disposed in contact with the second surface of a second, opposing liner or backing material to provide a layered assembly of first metal film/first liner or backing material/PSA ingredients/second liner or backing material/second metal film. The metal film may be made from stainless steel, steel, aluminum, brass, tin, copper, silver and gold, etc. The metal film may have a broad range of thickness, for example, a thickness of 0.01 to 0.5 mm, particularly 0.02 to 0.1 mm. In certain embodiments the thickness of the metal film is amenable to being readily bent or rolled around a core, which can gauge up to 3 millimeters (mm) and down to 2 micrometers.

The metal film assembly may be used for enhancing the curing of other PSAs such as those disclosed, for example, in WO 2011/156378, WO 2013/086014, WO 2013/086004 and WO 2013/086012, all of which are incorporated herein by reference in their entireties.

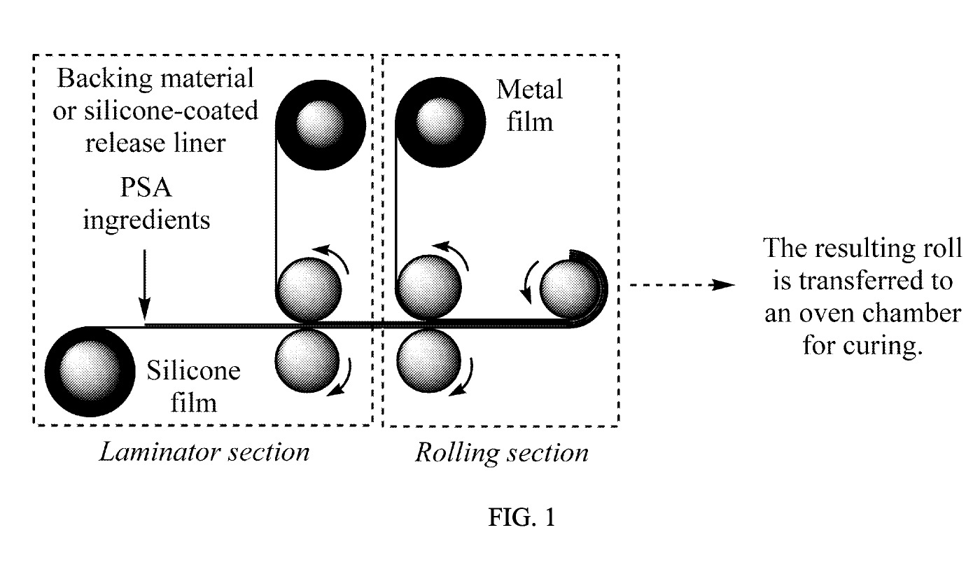

In certain embodiments, the liner(s) and/or backing material along with the metal film are rolled together to give a new sandwich assembly roll (FIG. 1), which may then be placed in an oven for further polymerization and curing of the reaction mixture.

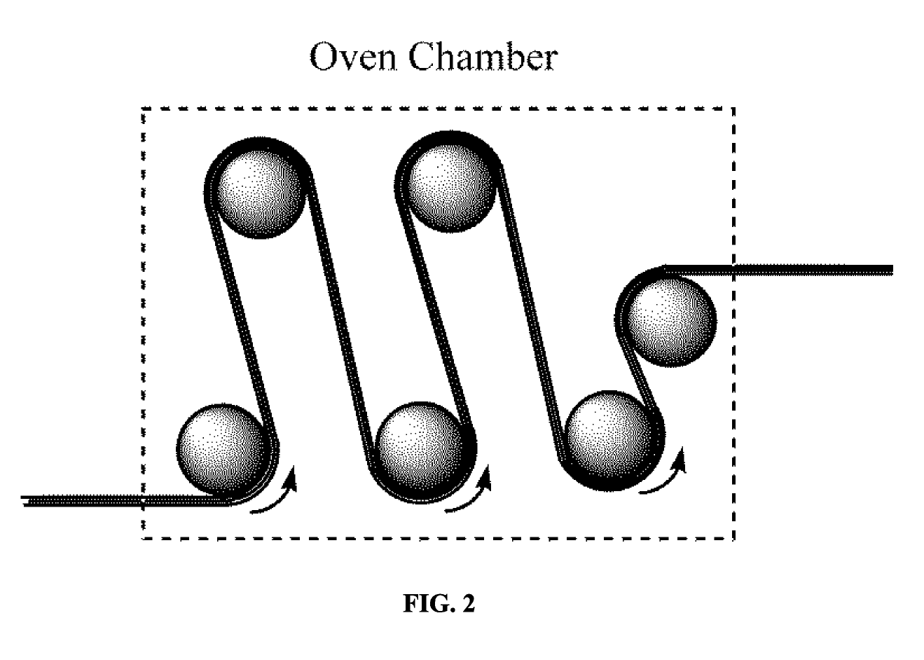

In some particular embodiments, the sandwich assembly can be mated with a metal film and rolled together immediately after the coating and laminator sections. In other particular embodiments, a pre-cure section may be inserted between the laminator section and rolling section, so as to allow the PSA ingredients pre-cured to solid state before the sandwich assembly is mated with metal film and rolled up. The pre-cure section may use an infrared tunnel, oven chamber (FIG. 2) or other efficient heating apparatus. In particular embodiments, a reactive calendaring can be used which is illustrated in FIG. 2. The reactive calendaring setup is a device that includes a series of rollers placed in an oven chamber. In some embodiments, the rollers may be unheated and disposed of inside an oven chamber at a preset temperature. In other embodiments, heated rollers can be used and the whole calendaring setup does not need to be housed in an oven chamber. The sandwich assembly is directed to heated calendar rollers or calendar rolls placed in an oven chamber at a preset temperature. The duration of the process can be fine-tuned by adjusting the number and sizes of the rolls or the travel distance of the assembly inside the oven chamber, so as to obtain an appropriate pre-cured PSA film.

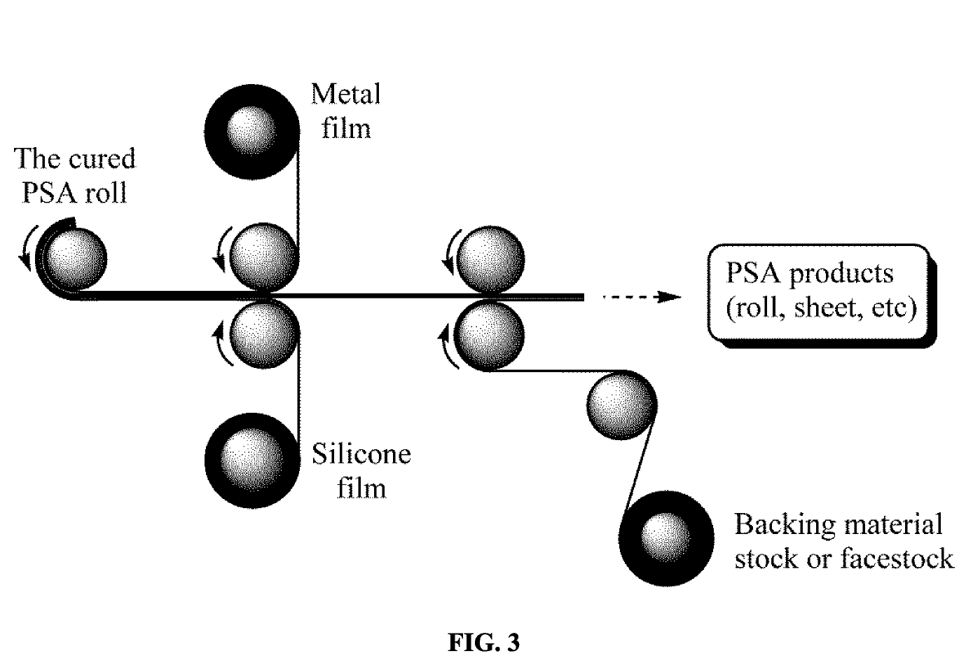

After the cure section, the roll is unwound to give the final PSA products or transfer the PSA layer to a backing material, and the release liner siliconised film and metal film can be removed, collected and reused (FIG. 3).

According to particular embodiments, the disclosed PSAs may be used to manufacture many different types of PSA constructs or articles. Thus, various flexible backings and liners may be used, including films (transparent and non-transparent), plastics such as PET film, BOPP and PVC film or modified natural substances such as cellophane, cloths, papers, non-woven fibrous constructions, metal foils, metalized plastics foils, aligned filaments, etc. The adhesive layers can be covered with paper or films which contain an adhesive-repellent layer, e.g. a separating layer consisting of silicone, for the protection of the adhesive layers on the PSA backings. The back side of the PSA films, tapes or foils can be coated with an adhesive-repellent coating (e.g., silicone coating) for facilitating rolling off the PSA.

### Example 1

This example describes the preparation of an epoxidized fatty acids mixture (EFAs) by saponification of epoxidized soybean oil (ESO, epoxy equivalent weight (EEW) ˜229) and acidification of the saponified products thereof. Sodium hydroxide (11.269 g, 0.2817 moles), Deionized water (DI-water, 47.3 mL), and ethanol (142.0 mL) were placed in a 500-mL three-necked round-bottom flask equipped with a stirrer, condenser, and thermometer. The mixture was stirred at r.t. for about 5 minutes to give a homogeneous solution, followed by the addition of ESO (79.68 g, containing about 0.256 moles of ester groups). The resulting mixture was then stirred (1600 rpm) at 43° C. (maintained by cooling or warming as required) until FT-IR analysis showed complete disappearance of the ester groups (it took about 23 minutes), to give a yellow, homogeneous (slightly cloudy) solution. Afterwards, the solution was cooled to room temperature, and dried under vacuum for 30 minutes to remove the majority of ethanol, resulting in an off-white “soap”. The soap was crushed to pieces and admixed with 80 mL of DI-water; the resulting mixture was then heated to 40° C. with stirring (800 rpm) until it turned homogeneous (slightly cloudy). Into the solution, about 75 mL of 3.7 N HCl solution (total HCl, 0.2789 moles) was added from a separatory funnel over a period of 4 minutes, and stirring was then allowed to maintain for another 5-7 minutes. The resulting milky mixture was transferred to a separatory funnel which was then placed in a water bath at about 50° C. After standing for a few minutes, the upper organic layer was collected and washed with hot brine (pre-heated to ˜55° C., ˜80 mL). The green-yellow, cloudy oil was collected and dried under vacuum at room temperature to afford a white, waxy product (74.82 g, ca 98% of theoretical yield). FT-IR and ¹H NMR analyses both confirmed that ESO was completely hydrolyzed to a mixture of free fatty acids, with almost complete retention of the oxirane moieties. FT-IR (neat, in cm⁻¹): 3049, 2985, 2944, 2871, 2911, 2849, 1693, 1469, 1300, 1262, 1226, 1195, 934, 847, 834, 818, and 719. ¹H NMR (400 MHz, CDCl3; δ, in ppm): 2.9-3.2 (methine protons of the oxirane ring), 2.28-2.43 (protons of CH₂ α to COOH), 1.72-1.90 (CH₂ protons between oxirane groups), 1.60-1.72 (protons of CH₂ β to COOH), 1.45-1.60 (protons of CH₂ α to the oxirane ring), 1.20-1.45 (protons of other methylene groups), 0.85-1.12 (protons of methyl groups). The carboxylic acid equivalent weight (CEW) of the product was determined by titration with alcoholic KOH to phenolphthalein end point, and found to be about 300. Based on the CEW value and the ratio of the integral of the signals observed at 2.9-3.2 ppm (methine protons of the oxirane ring) to that at 2.28-2.43 ppm (protons of CH₂ α to COOH), the oxirane equivalent weight of the product was determined to be about 230.

### Example 2

This example describes the preparation of a PSA composition from dimer acid (Aldrich; hydrogenated, average Mₙ˜570, monomer ≦0.1%, trimer acid ≦0.1%), epoxidized fatty acids mixture (EFAs, derived from epoxidized soybean oil as described in Example 1), and bisphenol A diglycidyl ether (BPAGE; from Aldrich; epoxy equivalent weight (EEW) ˜173) in a molar ratio of 0.95 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition. EFAs (8.8139 g), dimer acid (4.8180 g), and AMC-2 (0.2345 g) were placed in a 50-mL, round-bottom flask equipped with a silicone oil bath and magnetic stirrer, and heated up by the preheated oil bath (150° C.) with stirring (250 rpm). Heating and stirring were continued for 130 minutes at the same temperature to give a homogeneous (slightly cloudy), light yellow-green, and viscous resin. After the resin was cooled to about 95° C., BPAGE (1.7723 g) was added, the mixture was then heated in the preheated oil bath (95° C.) with stirring (100 rpm) for 12 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 23 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, pale yellow, uniform and “dry”. The product was characterized in terms of adhesion, tack, and shear tests (the test methods and conditions are described below in detail) with an Instron Testing Machine (model 5582). The test results showed that the PSA exhibits a good adhesive power, good tack, and sufficient cohesion strength (Table 1, Example 2).

Peel Test.

Peel adhesion (peel strength, or bond strength) is the force required to remove an adhesive from a test substrate or its own backing, which is typically measured using the 90° peel adhesion test method. In this study, the 90° peel adhesion test was performed on a stainless steel panel (type 302) in accordance with Test Method F of ASTM D3330/D3330M-04 (Reapproved 2010), with the main standards set forth as follows. Moving jaw (crosshead) speed is 12 inches/minute; test specimen width is 1 inch; tests are performed at 23±1° C. and 50±5% RH; dwell time is less than 1 min; data are collected after the first inch of specimen tape was peeled, and average peel adhesion strength in Newton is obtained for peeling the rest of the tape; five specimens are tested for each sample and averaged as reported values.

Shear Test.

The internal or cohesive strength of an adhesive film is known as shear strength, which is a measure of the internal strength of the adhesive itself. Shear properties are typically quantified using the static shear test method. In this study, shear tests were performed on a stainless steel panel (Type 302, mirror polished) in accordance with the Procedure A of ASTM D3654/D3654M-06. The time to failure (i.e., the tape separates completely from the test panel) is determined as the indication of shear strength (holding power). The main standards set forth in the Standard are described as follows. Tests are performed at 23±1° C. and 50±5% RH; specimen size is 1 inch by 1 inch; the test stand holds the test panel (and the PSA articles applied) at an angle of about 1° with the vertical; the test mass is 1000 grams; dwell time is less than 1 min; five specimens are tested for each sample and averaged as reported values.

Loop Tack Test.

Tack is the initial attraction (instant “grab”, quick stick) of an adhesive to a substrate with no external pressure applied, which may be measured as the force required to separate the adhesive from the substrate at the interface shortly after they have been brought into contact under a load equal only to the weight of the PSA article on a 1 inch² contact area. In this study, the Loop Tack test was performed on a stainless steel panel (Type 302) in accordance with Test Method A of ASTM D6195-03 (Reapproved 2011), maximum force (peak reading) required to break the adhesive bond is recorded for each specimen. The main standards are set forth as follows. Crosshead speed is 12 inches/minute; contact area of PSA specimen is 1 inch²; tests are performed at 23±1° C. and 50±5% RH; five specimens are tested for each sample and averaged as reported values.

For PSA applications, aging stability or resistance is usually required. Thus, the aging resistance of the PSA was studied by accelerated aging at 60° C. for determined intervals (up to 4 weeks). One week of accelerated aging at 60° C. is equivalent up to 9 months of natural aging. For ageing test, a Fisher Scientific Isotemp Standard Lab Incubators (Model 625D) was used to maintain a constant temperature of 60° C. for accelerated aging. After aging for predetermined intervals, the samples were tested for measurements of their aged adhesive properties according to the standard methods described above. Specimens aged at 60° C. were conditioned in the standard conditioning atmosphere (at 23±1° C. and 50±5% RH) for ˜10 h prior to the tests. The results showed that the above PSA exhibits good resistance to aging, with similar peel adhesion, loop tack and shear strength after aging for up to 4 weeks at 60° C.

TABLE 1
Reaction conditions and the pressure-sensitive adhesive performance of various
adhesives based on DA or AA, EFAs and epoxides.^{a}

| | Synthesis of | | | | | | | |
|---|---|---|---|---|---|---|---|---|
| | prepolymers | | | | | | | |
| | or | | polymerization | | | | | |
| | oligomers | | with difunctional | | | | | |
| | capped with | | or polyfunctional | | | | | |
| | COOH^{c} | | epoxides^{d} | | | | | |
| | COOH/ | | epoxides | | | | | |
| | epoxy | | (wt % base | | Cure | peel | | Shear |
| Example | molar | Time | on total | Time | time^{e} | strength^{f} | Loop | strength^{f} |
| No.^{b} | ratio^{g} | (min) | reactants) | (min) | (min) | (lbf/inch) | tack^{f} (lbf) | (hours) |
| 2 | 1.208 | 130 | BPAGE | 12 | 23 | 1.3 ± 0.1 | 1.3 ± 0.1 | — |
| | | | (11.51) | | | | | |
| 3 | 1.208 | 130 | BPAGE | 12 | 1084^{h} | 1.6 ± 0.1 | 1.6 ± 0.2 | — |
| | | | (11.51) | | | | | |
| 4 | 1.209 | 87 | BPAGE | 12 | 1080ⁱ | 1.9 ± 0.1 | 2.5 ± 0.2 | — |
| | | | (10.48) | | | | | |
| 5 | 1.209 | 87 | BPAGE | 12 | 16 | 1.4 ± 0.1 | 1.3 ± 0.1 | >2000 |
| | | | (10.48) | | | | | |
| 6 | 1.208 | 93 | BPAGE | 16 | 1085^{j} | 1.7 ± 0.1 | 1.7 ± 0.2 | — |
| | | | (10.02) | | | | | |
| 7 | 1.208 | 93 | BPAGE | 16 | 52 | 1.7 ± 0.1 | 1.6 ± 0.2 | — |
| | | | (10.02) | | | (2.0 ± 0.1^{k}) | | |
| 8 | 1.210 | 86 | BPAGE | 9 | 14 | 1.8 ± 0.1 | 2.2 ± 0.2 | — |
| | | | (9.39) | | | | | |
| 9 | 1.210 | 86 | BPAGE | 9 | 60 | 2.0 ± 0.3 | 2.6 ± 0.5 | — |
| | | | (9.39) | | | | | |
| 10 | 1.209 | 90 | BPAGE | 15 | 50 | 2.0 ± 0.2 | 2.2 ± 0.2 | — |
| | | | (9.27) | | | | | |
| 11 | 1.207 | 88 | TMPGE | 20 | 50 | 1.2 ± 0.2 | 1.5 ± 0.2 | — |
| | | | (6.11) | | | | | |
| 12 | 1.208 | 51 | BPAGE | 9 | 53 | 1.2 ± 0.2 | 0.8 ± 0.2 | — |
| | | | (13.32) | | | | | |
| 13 | 1.208 | 51 | BPAGE | 9 | 1085^{j} | 1.3 ± 0.2 | 0.8 ± 0.2 | — |
| | | | (13.32) | | | | | |
| 14 | 1.208 | 86 | BPAGE | 11 | 55 | 2.4 ± 0.2^{l} | 2.8 ± 0.2 | >192^{m} |
| | | | (10.15) | | | | | |
| 15 | 1.208 | 85 | BPAGE | 11 | 55 | 1.6 ± 0.2 | 1.6 ± 0.1 | — |
| | | | (10.22) | | | | | |
| 16ⁿ | 1.208 | 60 | BPAGE | 7 | 66 | 1.3 ± 0.1 | 2.0 ± 0.5 | — |
| | | | (10.06) | | | | | |

^{a}general conditions: AMC-2 (AFC Accelerator AMC-2, a 50 wt % solution of chromium (III) complex available from Ampac Fine Chemical LLC), 1.5 wt % to total reactants; abbreviations: DA, dimer acid (available from Aldrich; hydrogenated, average Mₙ ~570, monomer ≦0.1%, trimer acid ≦0.1%); AA, adipic acid (Aldrich, 99%); EFAs, epoxidized fatty acids mixture (epoxy equivalent weight or EEW, ~230; acid number, ~300); BPAGE, bisphenol A diglycidyl ether (Aldrich; EEW, 173); TMPGE, trimethylolpropane triglycidyl ether (EEW, 138).
^{b}PSA backing materials are PET film, except that paper is used as backing material in Example 9.
^{c}the reaction took place in oil bath at 150° C.; DA was used as a dicarboxylic acid, except that Example 12 and 13 used AA instead.
^{d}pre-polymerization took place in oil bath at 95° C.
^{e}cure reaction took place in an oven at 160° C. unless otherwise noted.
^{f}the 90° peel adhesion, shear, loop tack tests are according to test Method F of ASTM D3330/D3330M-04 (Reapproved 2010), Procedure A of ASTM D3654/D3654M-06, and Test Method A of ASTM D6195-03 (Reapproved 2011), respectively. Procedure and conditions are described in Example 2. The sample adhesives were cleanly removed in the tests, leaving no adhesive residue on the panel.
^{g}molar ratio of the carboxylic acid groups to the epoxy groups in the mixture of the starting reactants.
^{h}the reaction mixture was first cured in an oven at 160° C. for 4 minutes, and further cured in an oven at 103° C. for 18 hours after the PSA composition was transferred on PET backing.
ⁱcure reaction took place in an oven at 103° C.
^{j}the reaction mixture was first cured in an oven at 160° C. for 5 minutes, and further cured in an oven at 103° C. for 18 hours after the PSA composition was transferred on PET backing.
^{k}the sample was mated with stainless steel panel and dwelled for 20 minutes prior to the 90° peel adhesion test.
^{l}the sample was mated with stainless steel panel and dwelled for 20 minutes prior to the 180° peel adhesion test.
^{m}with a testing area of 0.5 inch by 1 inch and a weight of 1000 grams.
ⁿthe carboxylic acid used in this example is Unidyme 22 from Arizona Chemical (monomer ~1.3%, dimer acid ~81.3%, trimer and polymeric acid ~17.3%; carboxylic acid group equivalent weight ~294).

### Example 3

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.95 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (8.8139 g), dimer acid (4.8180 g), and AMC-2 (0.2345 g) were placed in a 50-mL, round-bottom flask equipped with a silicone oil bath and magnetic stirrer, and heated up by the preheated oil bath (150° C.) with stirring (250 rpm). Heating and stirring were continued for 130 minutes at the same temperature to give a homogeneous (slightly cloudy), light yellow-green, and viscous resin. After the resin was cooled to about 95° C., BPAGE (1.7723 g) was added, the mixture was then heated in the preheated oil bath (95° C.) with stirring (100 rpm) for 12 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 4 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The new assembly was further cured in an air-circulating oven maintained at 103° C. for another 18 hours. The final adhesive coating on the PET backing is thin, clear, shiny, light green-yellow, uniform and “dry”. The characterization in terms of adhesion, tack, and shear tests showed that the PSA exhibits a good adhesive power, good tack, and sufficient cohesion strength (Table 1, Example 3). The study of the ageing resistance of the PSA showed that the PSA exhibits good resistance to aging, with similar peel adhesion, loop tack and shear strength after ageing for up to 4 weeks at 60° C.

### Example 4

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.97 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition

EFAs (7.0415 g), dimer acid (3.8523 g), and AMC-2 (0.1775 g) were placed in a 50-mL, round-bottom flask equipped with a silicone oil bath and magnetic stirrer, and heated up by the preheated oil bath (150° C.) with stirring (250 rpm). Heating and stirring were continued for 87 minutes at the same temperature to give a homogeneous (slightly cloudy), light yellow-green, and viscous resin. After the resin was cooled to about 95° C., BPAGE (1.2760 g) was added, the mixture was then heated in the preheated oil bath (95° C.) with stirring (100 rpm) for 12 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 103° C. After 18 hours, the assembly was taken out of the oven. The released film was peeled off without taking away any adhesive composition (the release film has better release ability against the adhesive than the release paper), and a sheet of PET film backing was closely mated onto the adhesive layer with the use of the hot-melt laminator, to afford a PSA layer on the PET backing with the release paper left for the protection of the PSA. The adhesive coating on the PET backing is thin, clear, shiny, light yellow, uniform and “dry”. The characterization in terms of adhesion, tack, and shear tests showed that the PSA exhibits a good adhesive power, good tack, and sufficient cohesion strength (Table 1, Example 4). The study of the ageing resistance of the PSA showed that the PSA exhibits good resistance to aging, with similar peel adhesion, loop tack and shear strength after ageing for up to 4 weeks at 60° C.

### Example 5

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.97 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (7.0415 g), dimer acid (3.8523 g), and AMC-2 (0.1775 g) were placed in a 50-mL, round-bottom flask equipped with a silicone oil bath and magnetic stirrer, and heated up by the preheated oil bath (150° C.) with stirring (250 rpm). Heating and stirring were continued for 87 minutes at the same temperature to give a homogeneous (slightly cloudy), light yellow-green, and viscous resin. After the resin was cooled to about 95° C., BPAGE (1.2760 g) was added, the mixture was then heated in the preheated oil bath (95° C.) with stirring (100 rpm) for 12 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 16 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, pale green-yellow, uniform and “dry”. The characterization in terms of adhesion, tack, and shear tests showed that the PSA exhibits a good adhesive power, good tack, and sufficient cohesion strength (Table 1, Example 5).

### Example 6

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.98 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (7.5465 g), dimer acid (4.1306 g), and AMC-2 (0.1956 g) were placed in a 50-mL, round-bottom flask equipped with a silicone oil bath and magnetic stirrer, and heated up by the preheated oil bath (150° C.) with stirring (250 rpm). Heating and stirring were continued for 93 minutes at the same temperature to give a homogeneous (slightly cloudy), light yellow-green, and viscous resin. After the resin was cooled to about 95° C., BPAGE (1.3000 g) was added, the mixture was then heated in the preheated oil bath (95° C.) with stirring (100 rpm) for 16 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 5 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The new assembly was further cured in an air-circulating oven maintained at 103° C. for another 18 hours. The final adhesive coating on the PET backing is thin, clear, shiny, green-yellow, uniform and “dry”. The characterization in terms of adhesion, tack, and shear tests showed that the PSA exhibits a good adhesive power, good tack, and sufficient cohesion strength (Table 1, Example 6). The study of the ageing resistance of the PSA showed that the PSA exhibits good resistance to aging, with similar peel adhesion, loop tack and shear strength after ageing for up to 4 weeks at 60° C.

### Example 7

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.98 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (7.5465 g), dimer acid (4.1306 g), and AMC-2 (0.1956 g) were placed in a 50-mL, round-bottom flask equipped with a silicone oil bath and magnetic stirrer, and heated up by the preheated oil bath (150° C.) with stirring (250 rpm). Heating and stirring were continued for 93 minutes at the same temperature to give a homogeneous (slightly cloudy), light yellow-green, and viscous resin. After the resin was cooled to about 95° C., BPAGE (1.3000 g) was added, the mixture was then heated in the preheated oil bath (95° C.) with stirring (100 rpm) for 16 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 52 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, green-yellow, uniform and “dry”. The characterization in terms of adhesion, tack, and shear tests showed that the PSA exhibits a good adhesive power, good tack, and sufficient cohesion strength (Table 1, Example 7). The study of the ageing resistance of the PSA showed that the PSA exhibits good resistance to aging, with similar peel adhesion, loop tack and shear strength after ageing for up to 4 weeks at 60° C.

### Example 8

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 1.00 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (9.8150 g), dimer acid (5.3830 g), and AMC-2 (0.2443 g) were placed in a 50-mL, round-bottom flask equipped with a silicone oil bath and magnetic stirrer, and heated up by the preheated oil bath (150° C.) with stirring (250 rpm). Heating and stirring were continued for 86 minutes at the same temperature to give a homogeneous (slightly cloudy), light yellow-green, and viscous resin. After the resin was cooled to about 95° C., BPAGE (1.3000 g) was added, the mixture was then heated in the preheated oil bath (95° C.) with stirring (100 rpm) for 9 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 14 minutes, the assembly was taken out of the oven. The released film was peeled off without taking away any adhesive composition (the release film has better release ability against the adhesive than the release paper), and a sheet of PET film backing was closely mated onto the adhesive layer with the use of the hot-melt laminator, to afford a PSA layer on the PET backing with the release paper left for the protection of the PSA. The adhesive coating on the PET backing is thin, clear, shiny, green-yellow, uniform and “dry”. The characterization in terms of adhesion, tack, and shear tests showed that the PSA exhibits a good adhesive power, good tack, and sufficient cohesion strength (Table 1, Example 8).

### Example 9

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 1.00 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (9.8150 g), dimer acid (5.3830 g), and AMC-2 (0.2443 g) were placed in a 50-mL, round-bottom flask equipped with a silicone oil bath and magnetic stirrer, and heated up by the preheated oil bath (150° C.) with stirring (250 rpm). Heating and stirring were continued for 86 minutes at the same temperature to give a homogeneous (slightly cloudy), light yellow-green, and viscous resin. After the resin was cooled to about 95° C., BPAGE (1.3000 g) was added, the mixture was then heated in the preheated oil bath (95° C.) with stirring (100 rpm) for 9 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 60 minutes, the assembly was taken out of the oven. The released film was peeled off without taking away any adhesive composition (the release film has better release ability against the adhesive than the release paper), and a sheet of paper backing was closely mated onto the adhesive layer with the use of the hot-melt laminator, to afford a PSA layer on the PET backing with the release paper left for the protection of the PSA. The adhesive coating on the PET backing is thin, clear, shiny, green-yellow, uniform and “dry”. The characterization in terms of adhesion, tack, and shear tests showed that the PSA exhibits a good adhesive power, good tack, and sufficient cohesion strength (Table 1, Example 9).

### Example 10

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 1.00 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (8.6230 g), dimer acid (4.7276 g), and AMC-2 (0.2250 g) were placed in a 50-mL, round-bottom flask equipped with a silicone oil bath and magnetic stirrer, and heated up by the preheated oil bath (150° C.) with stirring (250 rpm). Heating and stirring were continued for 90 minutes at the same temperature to give a homogeneous (slightly cloudy), light yellow-green, and viscous resin. After the resin was cooled to about 95° C., BPAGE (1.3000 g) was added, the mixture was then heated in the preheated oil bath (95° C.) with stirring (100 rpm) for 15 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 50 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, green-yellow, uniform and “dry”. The characterization in terms of adhesion, tack, and shear tests showed that the PSA exhibits a good adhesive power, good tack, and sufficient cohesion strength (Table 1, Example 10). The study of the ageing resistance of the PSA showed that the PSA exhibits good resistance to aging, with similar peel adhesion, loop tack and shear strength after ageing for up to 4 weeks at 60° C.

### Example 11

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and trimethylolpropane triglycidyl ether (TMPGE; from Aldrich; epoxy equivalent weight (EEW) ˜138) in a molar ratio of 1.04 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (8.0765 g), dimer acid (4.410 g), and AMC-2 (0.2019 g) were placed in a 50-mL, round-bottom flask equipped with a silicone oil bath and magnetic stirrer, and heated up by the preheated oil bath (150° C.) with stirring (250 rpm). Heating and stirring were continued for 88 minutes at the same temperature to give a homogeneous (slightly cloudy), light yellow-green, and viscous resin. After the resin was cooled to about 95° C., TMPGE (0.8130 g) was added, the mixture was then heated in the preheated oil bath (95° C.) with stirring (100 rpm) for 20 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 50 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, green-yellow, uniform and “dry”. The characterization in terms of adhesion, tack, and shear tests showed that the PSA exhibits a good adhesive power, good tack, and sufficient cohesion strength (Table 1, Example 11).

### Example 12

This example describes the preparation of a PSA composition from adipic acid (Aldrich, 99%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.98 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of siliconized release liners with different adhesion-repellence (release) property for the adhesive composition.

EFAs (13.1088 g), adipic acid (1.8582 g), and AMC-2 (0.2625 g) were placed in a 50-mL, round-bottom flask equipped with a silicone oil bath and magnetic stirrer, and heated up by the preheated oil bath (150° C.) with stirring (250 rpm). Heating and stirring were continued for 51 minutes at the same temperature to give a homogeneous (slightly cloudy), light yellow-green, and viscous resin. After the resin was cooled to about 95° C., BPAGE (2.300 g) was added, the mixture was then heated in the preheated oil bath (95° C.) with stirring (100 rpm) for 9 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 53 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, pale green-yellow, uniform and “dry”. The characterization in terms of adhesion, tack, and shear tests showed that the PSA exhibits a good adhesive power, good tack, and sufficient cohesion strength (Table 1, Example 12). The study of the ageing resistance of the PSA showed that the PSA exhibits good resistance to aging, with similar peel adhesion, loop tack and shear strength after ageing for up to 4 weeks at 60° C.

### Example 13

This example describes the preparation of a PSA composition from adipic acid (Aldrich, 99%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.98 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (13.1088 g), adipic acid (1.8582 g), and AMC-2 (0.2625 g) were placed in a 50-mL, round-bottom flask equipped with a silicone oil bath and magnetic stirrer, and heated up by the preheated oil bath (150° C.) with stirring (250 rpm). Heating and stirring were continued for 51 minutes at the same temperature to give a homogeneous (slightly cloudy), light yellow-green, and viscous resin. After the resin was cooled to about 95° C., BPAGE (2.300 g) was added, the mixture was then heated in the preheated oil bath (95° C.) with stirring (100 rpm) for 9 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 5 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The new assembly was further cured in an air-circulating oven maintained at 103° C. for another 18 hours. The final adhesive coating on the PET backing is thin, clear, shiny, green-yellow, uniform and “dry”. The characterization in terms of adhesion, tack, and shear tests showed that the PSA exhibits a good adhesive power, good tack, and sufficient cohesion strength (Table 1, Example 13). The study of the ageing resistance of the PSA showed that the PSA exhibits good resistance to aging, with similar peel adhesion, loop tack and shear strength after ageing for up to 4 weeks at 60° C.

### Example 14

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.98 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of siliconized release liners and stainless steel foil.

EFAs (8.7568 g), dimer acid (4.7916 g), and AMC-2 (0.2350 g) were placed in a 50-mL, round-bottom flask equipped with a silicone oil bath and magnetic stirrer, and heated up by the preheated oil bath (150° C.) with stirring (250 rpm). Heating and stirring were continued for 86 minutes at the same temperature to give a homogeneous (slightly cloudy), light yellow-green, and viscous resin. After the resin was cooled to about 95° C., BPAGE (1.5305 g) was added, the mixture was then heated in the preheated oil bath (95° C.) with stirring (150 rpm) for 11 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 1.5 mil. The coating was then closely mated with a sheet of release film with the aid of the laminator, resulting in a “sandwich”-like assembly. The resulting assembly was mated and rolled together with a sheet of stainless steel foil (2 mil thick) onto a metal core to give a tight sandwich assembly roll. The stainless steel foil was used to increase the transfer efficiency of heat which is needed for the reactions to take place. The resulting roll was then placed in an air-circulating oven maintained at 160° C. for further polymerization and curing of the reaction mixture. After 55 minutes, the roll assembly was taken out of the oven and unwound. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, almost colorless, uniform and “dry”. The characterization in terms of adhesion, tack, and shear tests showed that the PSA exhibits a good adhesive power, good tack, and sufficient cohesion strength (Table 1, Example 14).

### Example 15

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.98 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of siliconized release liners and stainless steel foil.

EFAs (9.9145 g), dimer acid (5.4177 g), and AMC-2 (0.2678 g) were placed in a 50-mL, round-bottom flask equipped with a silicone oil bath and magnetic stirrer, and heated up by the preheated oil bath (150° C.) with stirring (250 rpm). Heating and stirring were continued for 85 minutes at the same temperature to give a homogeneous (slightly cloudy), light yellow-green, and viscous resin. After the resin was cooled to about 95° C., BPAGE (1.7460 g) was added, the mixture was then heated in the preheated oil bath (95° C.) with stirring (150 rpm) for 11 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 1.5 mil. The coating was then closely mated with a sheet of PET film with the aid of the laminator, resulting in a “sandwich”-like assembly. The resulting assembly was mated and rolled together with a sheet of stainless steel foil (2 mil thick) onto a metal core to give a tight sandwich assembly roll. The stainless steel foil was used to increase the transfer efficiency of heat which is needed for the reactions to take place. The resulting roll was then placed in an air-circulating oven maintained at 160° C. for further polymerization and curing of the reaction mixture. After 55 minutes, the roll assembly was taken out of the oven and unwound to give a PSA assembly (i.e., a PSA layer on the PET backing with the release paper left for the protection of the PSA). The adhesive coating on the PET backing is thin, clear, shiny, almost colorless, uniform and “dry”. The characterization in terms of adhesion, tack, and shear tests showed that the PSA exhibits a good adhesive power, good tack, and sufficient cohesion strength (Table 1, Example 15).

### Example 16

This example describes the preparation of a PSA composition from dimer acid (Unidyme 22 from Arizona Chemical; monomer ˜1.3%, dimer acid ˜81.3%, trimer and polymeric acid ˜17.3%; carboxylic group equivalent weight ˜294), mixture of epoxidized fatty acids (EFAs, derived from epoxidized soybean oil as described in Example 1), and bisphenol A diglycidyl ether (BPAGE; from Aldrich; epoxy equivalent weight (EEW) ˜173) in a molar ratio of 0.98 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of siliconized release liners and stainless steel foil.

EFAs (8.8293 g), dimer acid (4.9825 g), and AMC-2 (0.2375 g) were placed in a 50-mL, round-bottom flask equipped with a silicone oil bath and magnetic stirrer, and heated up by the preheated oil bath (150° C.) with stirring (250 rpm). Heating and stirring were continued for 60 minutes at the same temperature to give a homogeneous (slightly cloudy), light yellow-green, and viscous resin. After the resin was cooled to about 95° C., BPAGE (1.5445 g) was added, the mixture was then heated in the preheated oil bath (90° C.) with stirring (60 rpm) for 7 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 1.5 mil. The coating was then closely mated with a sheet of release film with the aid of the laminator, resulting in a “sandwich”-like assembly. The resulting assembly was mated and rolled together with a sheet of stainless steel foil (2 mil thick) onto a metal core to give a tight sandwich assembly roll. The stainless steel foil was used to increase the transfer efficiency of heat which is needed for the reactions to take place. The resulting roll was then placed in an air-circulating oven maintained at 160° C. for further polymerization and curing of the reaction mixture. After 66 minutes, the roll assembly was taken out of the oven and unwound. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, almost colorless, uniform and “dry”. The characterization in terms of adhesion, tack, and shear tests showed that the PSA exhibits a good adhesive power, good tack, and sufficient cohesion strength (Table 1, Example 16).

### Example 17

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil of Example 1), and bisphenol A diglycidyl ether (BPAGE; from Aldrich; epoxy equivalent weight (EEW) ˜173) in a molar ratio of 1.00 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (6.9510 g), dimer acid (3.8149 g), and AMC-2 (0.2002 g) were placed in a 50-mL, round-bottom flask equipped with a silicone oil bath and magnetic stirrer, and heated up by the preheated oil bath (150° C.) with stirring (250 rpm). Heating and stirring were continued for 83 minutes at the same temperature to give a homogeneous (slightly cloudy), light yellow-green, and viscous resin. After the resin was cooled to about 95° C., EFAs (1.1725 g) and BPAGE (0.8769 g) was added, the mixture was then heated in the preheated oil bath (95° C.) with stirring (100 rpm) for 16 minutes to afford a homogeneous, yellow-green, highly viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 60 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, green-yellow, uniform and “dry”. The characterization showed that the PSA exhibits a good adhesive power of about 1.6±0.3 lbf/inch against a substrate of stainless steel (type 302) as measured by a 90 degree peel test to stainless steel panels, has good tack (˜1.8 lbf, the maximum force required to remove the specimen loop with a 1×1 inch size from the stainless steel) and sufficient cohesion strength to resist splitting. The study of the ageing resistance of the PSA showed that the PSA exhibits good resistance to aging, with similar peel adhesion and loop tack after ageing for up to 4 weeks at 60° C.

### Example 18

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil of Example 1), and bisphenol A diglycidyl ether (BPAGE; from Aldrich; epoxy equivalent weight (EEW) ˜173) in a molar ratio of 1.00 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

EFAs (6.5699 g), dimer acid (3.6054 g), BPAGE (1.0377 g) and AMC-2 (0.1713 g) were placed in a 50-mL, round-bottom flask equipped with a silicone oil bath and magnetic stirrer, and heated up by the preheated oil bath (90° C.) with stirring (250 rpm). Heating and stirring were continued for 30 minutes at the same temperature to give a homogeneous (slightly cloudy), light green resin of medium viscosity. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 90 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, green-yellow, uniform and “dry”. The characterization showed that the PSA exhibits a good adhesive power of about 1.7±0.4 lbf/inch against a substrate of stainless steel (type 302) as measured by a 90 degree peel test to stainless steel panels, has good tack (2.5±0.6 lbf, the maximum force required to remove the specimen loop with a 1×1 inch size from the stainless steel) and sufficient cohesion strength to resist splitting. The study of the ageing resistance of the PSA showed that the PSA exhibits good resistance to aging, with similar peel adhesion and loop tack after ageing for up to 4 weeks at 60° C.

### Example 19

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil of Example 1), and bisphenol A diglycidyl ether (BPAGE; from Aldrich; epoxy equivalent weight (EEW) ˜173) in a molar ratio of 1.00 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

Dimer acid (4.3666 g), BPAGE (1.2613 g) and AMC-2 (0.1930 g) were placed in a 50-mL, round-bottom flask equipped with a silicone oil bath and magnetic stirrer, and heated up by the preheated oil bath (150° C.) with stirring (200 rpm). Heating and stirring were continued for 75 minutes at the same temperature to give a homogeneous (slightly cloudy), light yellow-green, and viscous resin. After the resin was cooled to about 90° C., EFAs (7.9500 g) was added, the mixture was then heated in the preheated oil bath (90° C.) with stirring (200 rpm) for 20 minutes to afford a homogeneous, yellow-green, and viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 90 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, green-yellow, uniform and “dry”. The characterization showed that the PSA exhibits a good adhesive power of about 1.8±0.3 lbf/inch against a substrate of stainless steel (type 302) as measured by a 90 degree peel test to stainless steel panels, has good tack (2.6±0.4 lbf, the maximum force required to remove the specimen loop with a 1×1 inch size from the stainless steel) and sufficient cohesion strength to resist splitting. The study of the ageing resistance of the PSA showed that the PSA exhibits good resistance to aging, with similar peel adhesion and loop tack after ageing for up to 4 weeks at 60° C.

### Example 20

This example describes the preparation of a PSA composition from dimer acid (Aldrich; hydrogenated, average Mₙ˜570, monomer ≦0.1%, trimer acid ≦0.1%), mixture of epoxidized fatty acids (EFAs, derived from epoxidized soybean oil of Example 1), and bisphenol A diglycidyl ether (BPAGE; from Aldrich; epoxy equivalent weight (EEW) ˜173) in a molar ratio of 0.89 total carboxylic acid groups to total oxirane groups present in the reactants prior to admixing, in the presence of AFC Accelerator AMC-2 (a 50 wt % solution of chromium (III) complex, available from Ampac Fine Chemical, LLC), and of PSA constructs comprising the composition with the aid of two siliconized release liners with different adhesion-repellence (release) property for the adhesive composition.

Dimer acid (2.3215 g), BPAGE (0.7357 g) and AMC-2 (0.1673 g) were placed in a 50-mL, round-bottom flask equipped with a silicone oil bath and magnetic stirrer, and heated up by the preheated oil bath (150° C.) with stirring (250 rpm). Heating and stirring were continued for 95 minutes at the same temperature to give a homogeneous (slightly cloudy), light yellow-green, and viscous resin. After the resin was cooled to about 100° C., EFAs (8.0225 g) was added, the mixture was then heated in the preheated oil bath (100° C.) with stirring (100 rpm) for 45 minutes to afford a homogeneous, yellow-green, and viscous resin. The resin was coated with the use of a hot-melt coater/laminator (Model Number, HLCL-1000; purchased from ChemInstruments, Inc., Fairfield, Ohio) onto a sheet of release paper in a coating thickness of ca 4.0 mg/cm². The coating was then closely mated with a sheet of release film, resulting in a “sandwich”-like assembly. The composition between the two release liners was subjected to further polymerization and curing reaction in an air-circulating oven maintained at 160° C. After 22 minutes, the assembly was taken out of the oven. The released film was peeled off without taking away any adhesive composition (the release film has better release ability against the adhesive than the release paper), and a sheet of PET film backing was closely mated onto the adhesive layer with the use of the laminator, to afford a PSA layer on the PET backing with the release paper left for the protection of the PSA. The adhesive coating on the PET backing is thin, clear, shiny, green-yellow, uniform and “dry” (smear-free). The characterization showed that the PSA exhibits a good adhesive power of about 1.3±0.2 lbf/inch against a substrate of stainless steel (type 302) as measured by a 90 degree peel test to stainless steel panels, has good tack (1.5±0.3 lbf, the maximum force required to remove the specimen loop with a 1×1 inch size from the stainless steel) and sufficient cohesion strength to resist splitting (shear strength >193 hours, measured by a room temperature shear test with a 0.5×1 inch samples size and a 1000-gram weight).

In view of the many possible embodiments to which the principles of the disclosed invention may be applied, it should be recognized that the illustrated embodiments are only preferred examples of the invention and should not be taken as limiting the scope of the invention.

1. A method for making a pressure sensitive adhesive comprising:
(I) (a) reacting (i) at least one dibasic or polybasic carboxylic acid or anhydride thereof with (ii) at least one first epoxidized fatty acid at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group; and
(b) curing the resulting carboxylic acid-capped prepolymer or oligomer with at least one difunctional epoxide or polyfunctional epoxide, and optionally at least one second epoxidized fatty acid, to produce a pressure sensitive adhesive, wherein the difunctional epoxide or polyfunctional epoxide is not an epoxidized vegetable oil; or
(II) (a) reacting (i) at least one dibasic or polybasic carboxylic acid or anhydride thereof with (ii) at least one difunctional or polyfunctional epoxide, at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group, wherein the difunctional or polyfunctional epoxide is not an epoxidized vegetable oil; and
(b) curing the resulting carboxylic acid-capped prepolymer or oligomer with at least one epoxidized fatty acid to produce a pressure sensitive adhesive; or
(III) (a) reacting (i) at least one epoxidized fatty acid, (ii) at least one dibasic or polybasic carboxylic acid or anhydride thereof and (iii) at least one difunctional or polyfunctional epoxide to produce a thermoplastic prepolymer or oligomer, wherein the difunctional or polyfunctional epoxide is not an epoxidized vegetable oil; and
(b) curing the resulting thermoplastic prepolymer or oligomer optionally to produce a pressure sensitive adhesive.

2. The method of claim 1, wherein the dibasic acid comprises a dimer acid or an adipic acid.

3. The method of claim 2, wherein the dimer acid has an average of two carboxylic acid groups per molecule.

4. The method of claim 2, wherein the dimer acid is a dimer of oleic acid and/or linoleic acid.

5. The method of claim 1, wherein the polyfunctional epoxide includes three or more epoxy functional groups.

6. The method of claim 5, wherein the polyfunctional epoxide comprises an aliphatic triglycidyl or polyglycidyl ether or an aromatic triglycidyl or polyglycidyl ether.

7. The method of claim 1, wherein the difunctional epoxide has two epoxy functional groups.

8. The method of claim 7, wherein the difunctional epoxide is selected from an alkyl diglycidyl ether, an alkyl diglycidyl ester, or a bisphenol diglycidyl ether.

9. The method of claim 1, wherein the amount of dibasic or polybasic acid or anhydride thereof reacted with the at least one first epoxidized fatty acid in step (I)(a) is in a molar ratio higher than 1.0 of total carboxylic acid groups present in the dibasic acid and the at least one first epoxidized fatty acid to epoxy functional groups present in the at least one first epoxidized fatty acid; or
wherein the amount of dibasic or polybasic acid or anhydride thereof reacted with the difunctional or polyfunctional epoxide in step (II)(a) is in a molar ratio higher than 1.0 of carboxylic acid groups present in the dibasic or polybasic acid to epoxy functional groups present in the at least one epoxidized fatty; or
wherein the reaction of the dibasic or polybasic acid or anhydride thereof reacted with the difunctional or polyfunctional epoxide and the at least one epoxidized fatty acid in step (III)(a) is at a molar ratio of carboxylic acid groups to epoxy groups in the reaction mixture of from about 3:1 to about 1:3, and the content of the at least one epoxidized fatty acid is from 5 to 95% based on the total weight of the reactants.

10. The method of claim 1, wherein the at least one epoxidized fatty acid is made from a plant oil.

11. The method of claim 10, wherein the plant oil is soybean oil.

12. The method of claim 1, wherein the epoxidized fatty acid has a structure of R—X₁—R—X₂—R—X₃—R—C(═O)—OH, wherein X₁, X₂, and X₃ each independently represent 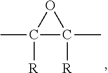
or a substituted or unsubstituted alkyl or heteroalkyl group, provided at least one of X₁, X₂, or X₃ is 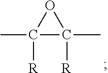
and each R independently represents hydrogen or a substituted or unsubstituted alkyl or heteroalkyl group.

13. The method of claim 1, wherein step (I)(a) further comprises heating the dibasic or polybasic acid or anhydride/at least one first epoxidized fatty acid reaction mixture at a temperature of 20 to 300° C. for 1 to 300 minutes; or
wherein step (II)(a) further comprises heating the dibasic or polybasic acid or anhydride/difunctional or polyfunctional epoxide reaction mixture at a temperature of 20 to 300° C. for 1 to 300 minutes; or
wherein step (III)(a) further comprises heating the reaction mixture of the dibasic or polybasic acid or anhydride thereof/difunctional or polyfunctional epoxide/at least one epoxidized fatty acid reaction mixture at a temperature of 20 to 300° C. for 1 to 480 minutes.

14. The method of claim 1, wherein step (I)(b) further comprises heating the carboxylic acid-capped thermoplastic prepolymer or oligomer/difunctional or polyfunctional epoxide and optionally one second epoxidized fatty acid reaction mixture at a temperature of 20 to 300° C. for 1 to 180 minutes; or
wherein step (II)(b) further comprises heating the reaction mixture of carboxylic acid-capped thermoplastic prepolymer or oligomer and at least one epoxidized fatty acid at a temperature of 20 to 300° C. for 1 to 240 minutes.

15. The method of claim 1, wherein (I) further comprises applying the carboxylic acid-capped thermoplastic prepolymer or oligomer/difunctional or polyfunctional epoxide reaction product onto a backing substrate or a release liner and heating the reaction product on the backing substrate or release liner at a temperature of 100-300° C. for 10 seconds to 400 minutes; or
wherein (II) further comprises applying the reaction product of carboxylic acid-capped thermoplastic prepolymer or oligomer and at least one epoxidized fatty acid onto a backing substrate or a release liner and heating the reaction product on the backing substrate or release liner at a temperature of 100-300° C. for 10 seconds to 400 minutes; or
wherein (III) further comprises applying the reaction product of the reaction mixture of the dibasic or polybasic acid or anhydride thereof/difunctional or polyfunctional epoxide/at least one epoxidized fatty acid onto a backing substrate or a release liner and heating the reaction product on the backing substrate or release liner at a temperature of 100-300° C. for 10 seconds to 400 minutes.

16. A pressure sensitive adhesive construct comprising:
(A) a backing substrate; and
(B) a pressure sensitive adhesive disposed on the backing substrate, wherein the pressure sensitive adhesive comprises a pressure sensitive adhesive made by any one of the methods of claims 1 to 15.

17. The construct of claim 16, wherein the pressure sensitive adhesive is included in a pressure sensitive adhesive composition wherein the composition comprises at least about 50 weight percent of the pressure sensitive adhesive, based on the total weight of the pressure sensitive adhesive composition.

18. A method for making a pressure sensitive adhesive construct comprising:
(I) reacting (i) at least one dibasic or polybasic carboxylic acid or anhydride thereof with (ii) at least one first epoxidized fatty acid at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group; curing the resulting carboxylic acid-capped prepolymer or oligomer with at least one difunctional epoxide or polyfunctional epoxide, and optionally at least one second epoxidized fatty acid, wherein the difunctional epoxide or polyfunctional epoxide is not an epoxidized vegetable oil; and forming on a backing substrate a pressure sensitive adhesive from the resulting reaction product; or
(II) reacting (i) at least one dibasic or polybasic carboxylic acid or anhydride thereof with (ii) at least one difunctional or polyfunctional epoxide, at a stoichiometric molar excess of reactive carboxylic acid groups relative to reactive epoxy groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group, wherein the difunctional or polyfunctional epoxide is not an epoxidized vegetable oil; curing the resulting carboxylic acid-capped prepolymer or oligomer with at least one epoxidized fatty acid to produce a pressure sensitive adhesive; and forming on a backing substrate a pressure sensitive adhesive from the resulting reaction product; or
(III) reacting (i) at least one epoxidized fatty acid, (ii) at least one dibasic or polybasic carboxylic acid or anhydride thereof and (iii) at least one difunctional or polyfunctional epoxide to produce a thermoplastic prepolymer or oligomer, wherein the difunctional or polyfunctional epoxide is not an epoxidized vegetable oil; curing the resulting thermoplastic prepolymer or oligomer optionally to produce a pressure sensitive adhesive; and forming on a backing substrate a pressure sensitive adhesive from the resulting reaction product.

19. The method of claim 18, wherein in (I) the forming of the pressure sensitive adhesive on the backing substrate comprises applying the carboxylic acid-capped thermoplastic prepolymer or oligomer/difunctional or polyfunctional epoxide reaction product to the backing substrate and thermally curing the carboxylic acid-capped thermoplastic prepolymer or oligomer/polyfunctional epoxide reaction product on the substrate to form the pressure sensitive adhesive.

20. The method of claim 18, wherein in (I)
the carboxylic acid-capped thermoplastic prepolymer or oligomer/difunctional or polyfunctional epoxide reaction product is applied onto a release liner or a backing substrate;
a backing substrate is placed onto a surface of the carboxylic acid-capped thermoplastic prepolymer or oligomer/difunctional or polyfunctional epoxide reaction product coating opposing the release liner, or a release liner is placed on a surface of the carboxylic acid-capped thermoplastic prepolymer or oligomer/difunctional or polyfunctional epoxide reaction product coating opposing the backing substrate, to form a release liner/reaction product/backing substrate assembly;
pressure is applied to the resulting assembly; and
at least the carboxylic acid-capped thermoplastic prepolymer or oligomer/difunctional or polyfunctional epoxide reaction product on the backing substrate or release liner is heated to produce the pressure sensitive adhesive composition.

21. The method of claim 18, wherein in (I) the method comprises:
applying the carboxylic acid-capped thermoplastic prepolymer or oligomer/difunctional or polyfunctional epoxide reaction product onto a first release liner;
placing a second release liner onto a surface of the reaction product coating opposing the first release liner to form a first release liner/reaction product/second release liner assembly;
applying pressure to the resulting assembly;
heating the resulting assembly;
removing the second release liner; and
placing a backing substrate onto a surface of the reaction product coating opposing the first release liner to form a first release liner/pressure sensitive adhesive/backing substrate assembly.

22. The method of claim 20, further comprising disposing a metal film in contact with at least one of the backing substrate or release liner to provide an assembly of a metal film/release liner/reaction product/backing substrate assembly or a release liner/reaction product/backing substrate/metal film assembly.

23. The method of claim 21, further comprising disposing a metal film in contact with at least one of the first release liner or second release liner to provide an assembly of a metal film/first release liner/reaction product/second release liner assembly or a first release liner/reaction product/second release liner/metal film assembly.

24. A method for making a pressure sensitive adhesive construct, comprising:
applying pressure sensitive adhesive-forming ingredients to a backing substrate or a release liner;
applying a release liner to an opposing surface of the pressure sensitive adhesive-forming ingredients applied to the backing substrate to form a release liner/pressure sensitive adhesive-forming ingredients/backing substrate assembly, or applying a backing substrate to an opposing surface of the pressure sensitive adhesive-forming ingredients applied to the release liner to form a backing substrate/pressure sensitive adhesive-forming ingredients/release liner assembly;
applying at least one metal film to an outward surface of the release liner/pressure sensitive adhesive-forming ingredients/backing substrate assembly or to an outward surface of the backing substrate/pressure sensitive adhesive-forming ingredients/release liner assembly;
applying pressure to the resulting assembly; and
heating the resulting assembly to form a pressure sensitive adhesive.

25. A method for making a pressure sensitive adhesive construct, comprising:
applying pressure sensitive adhesive-forming ingredients to a first release liner;
applying a second release liner to an opposing surface of the pressure sensitive adhesive-forming ingredients applied to the first release liner to form a first release liner/pressure sensitive adhesive-forming ingredients/second release liner assembly;
applying at least one metal film to an outward surface of the first release liner/pressure sensitive adhesive-forming ingredients/second release liner assembly;
applying pressure to the resulting assembly; and
heating the resulting assembly to form a pressure sensitive adhesive.

26. The method of claim 24, wherein applying pressure to the resulting assembly comprises rolling the resulting assembly together and then then heating the resulting assembly roll to form a pressure sensitive adhesive.

27-28. (canceled)

29. A pressure sensitive adhesive made from (i) at least one dibasic acid or anhydride thereof, (ii) at least one epoxidized fatty acid, and (iii) a difunctional epoxide selected from an alkyl diglycidyl ether, an alkyl diglycidyl ester, or a bisphenol diglycidyl ether; a polyfunctional epoxide selected from an aliphatic triglycidyl or polyglycidyl ether or an aromatic triglycidyl or polyglycidyl ether; or a mixture of a difunctional epoxide and a polyfunctional epoxide.
